(19) United States
(12) Patent Application Publication
(10) Pub. No.: US 2009/0061117 A1
(43) Pub. Date: Mar. 5, 2009

(54) Sealant for one drop fill process, vertically conducting material and liquid crystal display device

(76) Inventors: Yuichi Oyama, Shiga (JP); Hideyasu Nakajima, Ibaraki (JP); Takashi Watanabe, Osaka (JP); Takuya Yamamoto, Shiga (JP); Mitsuru Tanikawa, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 11/920,060

(22) PCT Filed: May 8, 2006
(86) PCT No.: PCT/JP2006/309240

§ 371 Date: Jan. 24, 2008

(30) Foreign Application Priority Data
May 9, 2005 (JP) 2005-136686
Jul. 6, 2005 (JP) 2005-198138

(51) Int. Cl. C09K 19/00; C08F 232/04; C08F 232/08; C08F 20/10

(52) U.S. Cl. 428/1.54; 526/281; 526/308; 522/183

(57) ABSTRACT

It is an object of the present invention to provide a sealant for a One prop Fill process which hardly causes a peeling phenomenon between the sealant and a substrate in production of liquid crystal display device since the sealant has excellent adhesion to the substrate, and which is most suitable for producing a liquid crystal display device having low color irregularity in liquid crystal display since the sealant does not cause liquid crystal contamination, and relates to a sealant for a One prop Fill process, in which in production of liquid crystal display device by a One prop Fill process, even a portion where light may be not directly irradiated can be adequately cured, a liquid crystal is not deteriorated by ultraviolet light to be irradiated in curing the sealant, and high display quality and high reliability of the liquid crystal display device can be realized, a vertically conducting material, and a liquid crystal display device obtained by using these.

The present invention is directed to a sealant for a One prop Fill process, which contains a (meth)acrylate compound having a structure represented by the following general formula (1), 10 to 70% by weight of a curable resin component contained in the sealant being the (meth)acrylate compound.

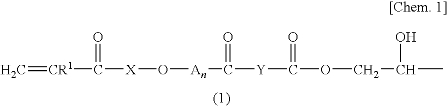

In the general formula (1), R¹ represents a hydrogen atom or a methyl group, X represents one species selected from the group expressed by the following chemical formula (2), Y represents one species selected from the group expressed by the following chemical formula (3), A represents a ring opening structure of cyclic lactone, and n has a value of zero or one.

### TECHNICAL FIELD

The present invention relates to a sealant for a One prop Fill process which hardly causes a peeling phenomenon between the sealant and a substrate in production of liquid crystal display device since the sealant has excellent adhesion to the substrate, and which is most suitable for producing a liquid crystal display device having low color irregularity in liquid crystal display since the sealant does not cause liquid crystal contamination, and relates to a sealant for a One prop Fill process, in which in production of liquid crystal display device by a One prop Fill process, even a portion where light may be not directly irradiated can be adequately cured, a liquid crystal is not deteriorated by ultraviolet light to be irradiated in curing the sealant, and high display quality and high reliability of the liquid crystal display device can be realized, a vertically conducting material, and a liquid crystal display device obtained by using these.

### BACKGROUND ART

Previously, a liquid crystal display devices such as liquid crystal display cell and the like have been produced by opposing two transparent substrates with an electrode at a prescribed space, forming a cell by sealing their around with a sealant comprising of a curable resin composition, filling liquid crystal into the cell through a liquid crystal filling port provided at a part of the sealant, and sealing the liquid crystal filling port with the sealant or a end-sealing material.

In this method, first, a seal pattern, which uses a thermosetting sealant and is provided with a liquid crystal filling port, is formed on one of two transparent substrates with an electrode by a screen printing method, and pre-baked at 60 to 100° C. to dry a solvent in the sealant. Next, two substrates are located on opposite sides of a spacer, aligned, and bonded. Bonded substrates are subjected to heat press at 110 to 220° C. for 10 to 90 minutes, and after adjusting gaps near the seal, the sealant is heated at 110 to 220° C. for 10 to 120 minutes in an oven to cure the sealant fully. Then, liquid crystal is filled through the liquid crystal filling port, and finally the liquid crystal filling port is sealed with the end-sealing material to fabricate a liquid crystal display device.

However, in accordance with this production method, there were problems that displacement of position, variations in gaps, and reduction in adhesion of a sealant to a substrate occur due to thermal strain; a remaining solvent is thermally expanded and air bubbles are produced, and this causes variations in gaps and a seal pass; curing time of seal is long; a pre-baking process are complicated; serviceable time of a sealant is short due to vaporization of a solvent; it takes much time to fill liquid crystal. Particularly, in a recent large-size liquid crystal display device, taking much time to fill liquid crystal becomes a large issue.

On the other hand, a method of producing a liquid crystal display device, referred to as a One prop Fill process, which uses a sealant comprising a resin composition having both photo-curability and a thermosetting property is studied (see, for example, Patent Document 1). In the One prop Fill process, first, a rectangular seal pattern is formed on one of two transparent substrates with an electrode by a screen printing method. Next, a small droplet of liquid crystal is dispensed and applied to the whole area within a frame of the transparent substrate in a state of keeping the sealant uncured, and on this, the other transparent substrate is immediately overlaid, and ultraviolet light is irradiated to the sealed portion to cure the sealant temporarily. Thereafter, in annealing the liquid crystal, the sealant is heated to be cured fully to prepare a liquid crystal display device. If bonding of the substrate is performed under a reduced pressure, the liquid crystal display device can be produced with extremely high efficiency, and currently, this One prop Fill process become a dominant production method of the liquid crystal display device.

As sealant used in a conventional production process, for example, an adhesive which is predominantly composed of a partially (meth)acrylated product of a bisphenol A type epoxy resin is disclosed in Patent Document 2. In addition to this, similar sealants are disclosed in Patent Document 3, Patent Document 4, Patent Document 5, Patent Document 6 and the like. Further, in Patent Document 4, a liquid crystal sealant which is predominantly composed of (meth)acrylate is disclosed.

However, in such a One prop Fill process, while it becomes possible to reduce a time for an introducing step of a liquid crystal significantly in comparison with a vacuum filling method, there was a problem that since the sealant comes into contact with a liquid crystal in an uncured state, components of the sealant are apt to elute into a liquid crystal and this causes liquid crystal contamination.

For such a problem, for example, a method of curing in two steps by ultraviolet light and heating using a sealant having both photo-curability and a thermosetting property is known. In such curing in two steps, when the proportion of the sealant photo-cured is higher, the elution of components of the sealant into a liquid crystal can be more suppressed.

But, generally, when the sealant is cured, the adhesion to the substrate is deteriorated and adhesive property becomes low since stress is produced in a cured substance. Particularly when a liquid crystal display device having a structure, in which a substrate 21 provided with a layer 22 of a single layer or multi-layer such as a alignment layer and a black matrix is bonded to another substrate 23 through a sealant 20 and liquid crystal 24 is filled and sealed as shown in FIG. 2, is produced by a One prop Fill process, there was a problem that an adhesive force between the cured sealant and the substrate (layer) is reduced and a peeling phenomenon between them becomes remarkable. Further, FIG. 2 is a sectional view schematically showing an example of a liquid crystal display device.

Further, in recent years, picture-frames of a liquid crystal display part are narrowed aimed at a downsizing of equipment associated with the widespread use of various mobile equipment with a liquid crystal panel such as mobile phones, mobile game machines and the like, and therefore patterns of the sealant to be formed on a substrate is increasingly located at a position overlapping with the black matrix (BM) or the like in the thickness direction of a liquid crystal cell. And, this had a problem that in such the sealant formed at a position overlapping with the BM or the like, since an uncured portion remains even after irradiating light such as ultraviolet light, a sealant components are eluted from this uncured portion into a liquid crystal and this further causes liquid crystal contamination.

For such a problem, for example, a method of irradiating light from a backside of the substrate, namely an array side, is conceivable. However, since there are also metal wirings, transistors and the like on an array substrate, some portion of the sealant is not irradiated with light and an uncured portion remains even after irradiating light. Particularly when the portion not irradiated with light is 50 μm or more, there was a problem that an uncured portion of the sealant is apt to develop, and if this uncured portion comes into contact with a liquid crystal, this causes liquid crystal contamination and liquid crystal display color irregularity is apt to occur.

On the other hand, when a liquid crystal display device is produced by a One prop Fill process using a conventional sealant, it is necessary to irradiate ultraviolet light, having high energy, with a short wavelength in order to cure adequately the sealant.

However, in the production of the liquid crystal display device by a One prop Fill process, there was also a problem that since ultraviolet light irradiated to cure the sealant is irradiated to a liquid crystal in no small part, curing of the sealant with ultraviolet light, having high energy, with a short wavelength causes simultaneously deterioration of the liquid crystal, resulting in significant reduction in display quality of the liquid crystal display device, and decrease in reliability.

### Patent Document 1: Japanese Kokai Publication 2001-133794

### Patent Document 2: Japanese Kokai Publication Hei-6-160872

### Patent Document 3: Japanese Kokai Publication Hei-1-243029

### Patent Document 4: Japanese Kokai Publication Hei-7-13173

### Patent Document 5: Japanese Kokai Publication Hei-7-13174

### Patent Document 6: Japanese Kokai Publication Hei-7-13175

### DISCLOSURE OF THE INVENTION

### Roblems to be Solved by the Invention

In view of the above-mentioned state of the art, it is an object of the present invention to provide a sealant for a One prop Fill process which hardly causes a peeling phenomenon between the sealant and a substrate in production of liquid crystal display device since the sealant has excellent adhesion to the substrate, and which is most suitable for producing a liquid crystal display device having low color irregularity in liquid crystal display since the sealant does not cause liquid crystal contamination, and to provide a sealant for a One prop Fill process, in which in production of liquid crystal display device by a One prop Fill process, even a portion where light may be not directly irradiated can be adequately cured, a liquid crystal is not deteriorated by ultraviolet light to be irradiated in curing the sealant, and high display quality and high reliability of the liquid crystal display device can be realized, a vertically conducting material, and a liquid crystal display device formed by using these materials.

### Means for Solving the Problems

The first present invention pertains to a sealant for a One prop Fill process, which contains a (meth)acrylate compound having a structure represented by the following general formula (1), 10 to 70% by weight of a curable resin component contained in the sealant being the (meth)acrylate compound.

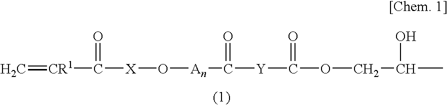

In the general formula (1), R¹ represents a hydrogen atom or a methyl group, X represents one species selected from the group expressed by the following chemical formula (2), Y represents one species selected from the group expressed by the following chemical formula (3), A represents a ring opening structure of cyclic lactone, and n has a value of zero or one.

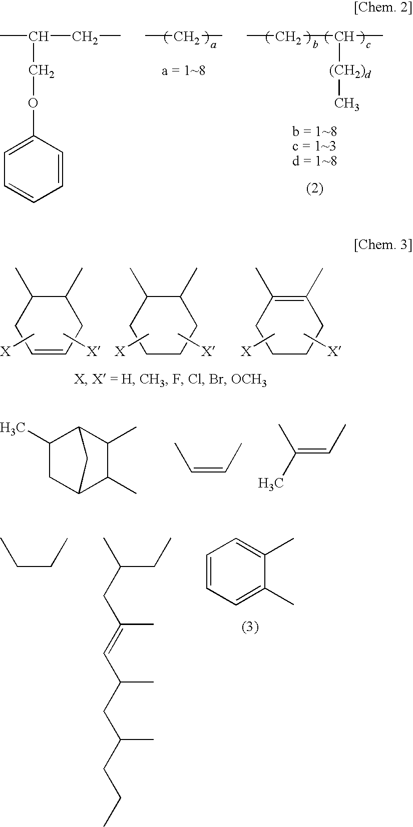

Further, the second present invention pertains to a sealant for a One prop Fill process, which contains a radical polymerization initiator for generating an activated radical by irradiation of light, a curable resin and solid organic acid hydrazide, the radical polymerization initiator having a molar absorption coefficient of 100 to 100000 M⁻¹·cm⁻¹ at 350 nm, measured in acetonitrile, and 60 mol % or more of a reactive functional group contained in said curable resin being a (meth)acryloyl group.

Hereinafter, the present invention will be described in detail.

The present inventors made intense investigations, and consequently found that by using a (meth)acrylate compound having a specific structure as a sealant for a One prop Fill process, the sealant can become one which has relatively low viscosity and excellent workability, and does not cause liquid crystal contamination and can produce the liquid crystal display device having low color irregularity in liquid crystal display, and further has excellent adhesion to a substrate surface on which a layer such as an alignment layer after curing or a black matrix is formed, leading to completion of the first present invention.

The present inventors has hitherto proposed a sealant for a liquid crystal display device, which uses a curable resin composition containing an acrylated epoxy resin, as a sealant suitable particularly in a One prop Fill process.

When such a curable resin composition is used, the sealant for a liquid crystal display device can be used as a sealant of combined photo-curable and thermosetting type, and further liquid crystal contamination can be effectively prevented since a resin contained in the sealant has high polarity and low compatibility with a liquid crystal. But, there was a problem that when a layer such as an alignment layer or a black matrix is formed on a substrate surface on which the sealant is formed, an adhesive force between the sealant and the substrate surface is decreased after photocuring

The present inventors made intense investigations, and consequently found that by using a (meth)acrylate compound having a specific structure as a sealant for a One prop Fill process, the sealant can become one which has excellent adhesion to a substrate surface on which a layer such as an alignment layer after curing or a black matrix is formed, leading to completion of the first present invention.

Further, the present inventors made intense investigations, and consequently found that if the sealant for a One prop Fill process has a property of being cured by ultraviolet light with a long wavelength of the order of 350 nm, when it is applied to a One prop Fill process, even sealant in an area, ultraviolet light to which is blocked by the black matrix (BM) or the like, can be adequately cured, and a liquid crystal is not deteriorated since the energy of ultraviolet light is low, leading to completion of the second present invention.

The sealant for a One prop Fill process of the first present invention (hereinafter, also simply referred to as a sealant of the first present invention) contains a (meth)acrylate compound having a structure expressed by the above-mentioned general formula (1).

In the above-mentioned general formula (1), X represents one species selected from the group expressed by the above-mentioned chemical formula (2), Y represents one species selected from the group expressed by the above-mentioned chemical formula (3), A represents a ring opening structure of cyclic lactone, and n has a value of zero or one. Since the sealant of the first present invention containing a (meth)acrylate compound having such a structure has excellent adhesion to a substrate, it hardly causes a peeling phenomenon between the sealant and the substrate, and since the sealant of the first present invention does not cause liquid crystal contamination, it is most suitable for producing the liquid crystal display device which is low in color irregularity in liquid crystal display.

Incidentally, in the present description, (meth)acrylate means acrylate or methacrylate.

The structure of another portion of the above-mentioned (meth)acrylate compound is not particularly limited as long as the (meth)acrylate compound has a structure expressed by the above-mentioned general formula (1).

Further, the above-mentioned (meth)acrylate compound preferably has a structure derived from lactone. The sealant of the present invention comes to have excellent flexibility, and therefore reductions in an adhesive force to a substrate surface due to internal stress produced in curing the sealant hardly occurs and a peeling phenomenon between the sealant and the substrate does not occur. In this case, n of the A in the above-mentioned general formula (1) is 1.

The above-mentioned cyclic lactone is not particularly limited and includes, for example, γ-undecalactone, ε-caprolactone, γ-decalactone, σ-dodecalactone, γ-nonalactone, γ-nonanolactone, γ-valerolactone, σ-valerolactone, β-butyrolactone, γ-butyrolactone, β-propiolactone, σ-hexanolactone, and γ-butyl-2-oxepanone. These cyclic lactones may be used alone or in combination of two or more species.

Among others, lactone, which is ring-opened to form a straight chain portion of a main skeleton having 5 to 7 carbon atoms, is preferred.

Further, the above-mentioned (meth)acrylate compound preferably has a segment consisting of three or more interlinked methylene groups. Thereby, the sealant of the first present invention comes to have excellent flexibility, and therefore reductions in an adhesive force to a substrate surface due to internal stress produced in curing the sealant hardly occurs and a peeling phenomenon between the sealant and the substrate does not occur.

Further, the above-mentioned (meth)acrylate compound is preferably a polyfunctional (meth)acrylate compound having two or more (meth)acryl groups. When the above-mentioned (meth)acrylate compound is a polyfunctional material having two or more (meth)acryl groups, a cured substance of the sealant of the first present invention becomes superior in heat resistance and high in reliability because of an enhanced crosslinking density.

In the sealant of the present invention, a (meth)acrylate compound having a structure expressed by the above-mentioned general formula (1) can be obtained, for example, by a reaction shown in the following formula (4).

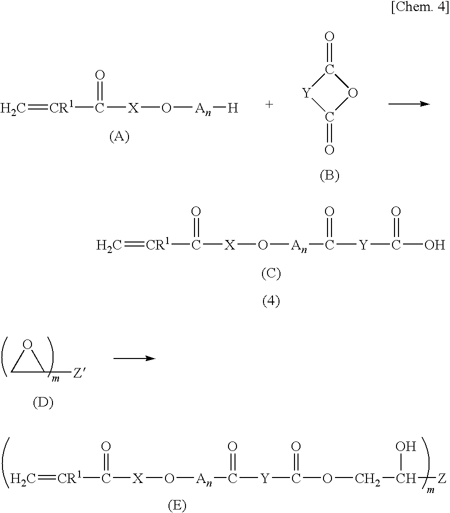

That is, carboxylic acid (C) is obtained by reacting (meth)acrylate (A) with a cyclic anhydride (B). Then, by reacting the carboxylic acid (C) with an epoxy compound (D), the (meth)acrylate compound (E) having a structure expressed by the above-mentioned general formula (1) is obtained.

X and A in the above-mentioned (meth)acrylate (A) include the same substances, respectively, as X and A in the structure expressed by the general formula (1) of the above-mentioned (meth)acrylate compound.

Further, the above-mentioned (meth)acrylate (A) preferably has a structure derived from lactone. When the above-mentioned (meth)acrylate (A) has a structure derived from lactone, a (meth)acrylate compound (E) to be synthesized will have a structure derived from lactone. When the above-mentioned (meth)acrylate (A) has the structure derived from lactone, n in the above-mentioned A is 1.

Specific examples of the above-mentioned (meth)acrylate (A) having the structure derived from lactone include, for example, caprolactone-2-(meth)acroyloxyethyl, dicaprolactone-2-(meth)acroyloxyethyl, aliphatic epoxy acrylate (Ebecryl 111, Ebecryl 112, both produced by DAICEL-CYTEC Co., Ltd.), and EPOLIGHT 1600 (produced by KYOEISHA CHEMICAL Co., Ltd.) containing a straight chain structure comprising six interlinked methylene groups.

A method of synthesizing the above-mentioned (meth)acrylate (A) having a structure derived from lactone is not particularly limited and includes publicly known methods, and examples of the method include a method of mixing (meth)acrylic ester having a hydroxyl group like 2-hydroxyethyl acrylate with the above-mentioned cyclic lactone and heating the resulting mixture to react them.

Y in the above-mentioned cyclic anhydride (B) includes the same substance as Y in the structure expressed by the general formula (1) of the above-mentioned (meth)acrylate compound.

Examples of such a cyclic anhydride (B) includes maleic anhydride, succinic anhydride, phthalic anhydride, citraconic anhydride, Rikacid TH, Rikacid HT-1, Rikacid HH, Rikacid HT-700, Rikacid MH, Rikacid MT-500, Rikacid HNA, Rikacid HNA-100, Rikacid OSA, and Rikacid DDSA (all produced by New Japan Chemical Co., Ltd.).

In the epoxy compound (D) in the above-mentioned formula (4), m represents an integer of 1 or more. Such the epoxy compound (D) may be monofunctional epoxy or polyfunctional epoxy, and its structure is not particularly limited as long as it is a compound having at least an epoxy group. That is, in the above-mentioned formula (4), Z′ comprising the epoxy compound (D) is not particularly limited and it may be any structure.

Examples of the above-mentioned epoxy compound (D) include, specifically as a monofunctional epoxy compound, n-butyl glycidyl ether of Rikaresin L-100 (produced by New Japan Chemical Co., Ltd.), EPICLON 520 and EPICLON-703 (all produced by DAINIPPON INK AND CHEMICALS, INCORPORATED), glycidyl (meth)acrylate, and 4-hydroxybutyl acrylate glycidyl, and the above-mentioned epoxy compound (D) is preferably one in which number of carbon atoms comprising of a main chain is 10 or less. Further, examples of bifunctional epoxy compounds of polyfunctional epoxy compounds include bisphenol type epoxy compounds such as EPICLON EXA-850CRP (produced by DAINIPPON INK AND CHEMICALS, INCORPORATED), hydrogenated bisphenol type epoxy compounds such as EPICLON EXA-7015 (produced by DAINIPPON INK AND CHEMICALS, INCORPORATED) and ethylene glycol diglycidyl ether, and examples of trifunctional or higher functional epoxy compounds include EPICLON 725 (produced by DAINIPPON INK AND CHEMICALS, INCORPORATED). And, the above-mentioned bisphenol type and hydrogenated bisphenol type epoxy compounds include, for example, A type, E type and F type.

The above-mentioned epoxy compound (D) is preferably a bifunctional or higher functional epoxy compound having two or more epoxy groups. By using such the epoxy compound (D), the (meth)acrylate compound (E) to be synthesized can become the polyfunctional (meth)acrylate compound having two or more (meth)acryl groups described above. Specifically, the polyfunctional (meth)acrylate compound having two or more (meth)acryl groups is prepared by reacting 1 mol of the above-mentioned epoxy compound (D) with carboxylic acid (C) of number of moles corresponding to number of epoxy groups of the above-mentioned epoxy compound (D). In this case, m in the above-mentioned (meth)acrylate compound (E) is equal to number of (meth)acryl groups in the above-mentioned (meth)acrylate compound (E). The above-mentioned (meth)acrylate compound (E) is particularly tetrafunctional or higher functional.

Z in the (meth)acrylate compound (E) produced by such a method is not particularly limited and, for example, Z may have the same structure as Z′ comprising the above-mentioned epoxy compound (D), but when Z′ in the above-mentioned epoxy compound (D) contains one or more epoxy groups, Z may have a structure in which a part of or all of the epoxy group in the Z′ react with the above-mentioned carboxylic acid (C) or arbitrary acrylic acid.

Specific examples of the above-mentioned (meth)acrylate compound (E) include KRM 7856, Ebecryl 3708 (all produced by DAICEL-CYTEC Co., Ltd.).

It is preferred to use a catalyst for the purpose of attaining an adequate reaction rate in obtaining the above-mentioned (meth)acrylate compound (E).

The above-mentioned catalyst is not particularly limited and includes, for example, organic phosphine compounds such as triphenylphosphine and the like, tertiary amines such as triethylamine, benzyldimethylamine and the like, quaternary ammonium salts such as trimethylammonium chloride, triethylbenzylammonium chloride, trimethylammonium bromide and the like, imidazole compounds such as 2-methylimidazole, 2-ethyl-4-methylimidazole, 1-benzyl-2-methylimidazole and the like, and organometallic salts such as chromium octenate, cobalt octenate, chromium naphtenate and the like.

A preferred lower limit of an amount of the above-mentioned catalyst to be added is 0.01% by weight, and a preferred upper limit is 5.0% by weight. When the amount of the catalyst to be added is less than 0.01% by weight, the adequate reaction rate may not be attained, and when this amount is more than 5.0% by weight, this may adversely affects various properties of the sealant of the first present invention. More preferably, the lower limit is 0.05% by weight and the upper limit is 2.0% by weight. Further, when the above-mentioned (meth)acrylate compound (E) is obtained, it is preferred to add a polymerization inhibitor for the purpose of preventing the polymerization of a (meth)acrylic group.

The polymerization inhibitor is not particularly limited and includes, for example, hydroquinone, hydroquinone monomethyl ether, phenothiazine-p-tert-butylcatechol, 2,5-di-tert-butylhydroquinone, mono-tert-butylhydroquinone, p-benzoquinone, naphthoquinone, 2,5-diphenyl-p-benzoquinone, di-tert-butyl-p-cresol, 2,5-di-tert-butyl-4-methylphenol, and p-methoxyphenol and the like.

Further, the above-mentioned reaction of the carboxylic acid (C) and the epoxy compound (D) is preferably performed until an acid value becomes 2 mgKOH or less. When the acid value is more than 2 mgKOH, the carboxylic acid (C) still remains much and an amount of the (meth)acrylate compound (E) is insufficient. And, the above reaction is preferably performed until the concentration of oxygen of oxirane becomes 1% or less. When the concentration of oxygen of oxirane is more than 1%, the epoxy compound (D) still remains much and an amount of the (meth)acrylate compound (E) is insufficient.

Incidentally, the above-mentioned reaction is preferably performed while measuring an acid value and a concentration of oxygen of oxirane by a method of a titration method or the like.

In the sealant of the first present invention, a lower limit of the amount of the above-mentioned (meth)acrylate compound to be mixed in the above-mentioned curable resin is 10% by weight and an upper limit is 70% by weight. When this amount is less than 10% by weight, a residual stress of a cured substance of the sealant of the first present invention cannot be adequately relaxed, and adhesion between the substrates of a produced liquid crystal display device becomes insufficient. When the amount is more than 70% by weight, since the cured substance of the sealant of the first present invention disperses the residual stress, the adhesion between the substrates of a produced liquid crystal display device is enhanced, but the workability such as a dispensing property of the sealant of the first present invention becomes extremely low.

The sealant of the first present invention may further contain other curable resins in addition to the (meth)acrylate compound having a structure expressed by the above-mentioned general formula (1). The above-mentioned curable resin is not particularly limited and includes curable resins having cyclic ethers, styryl groups or the like such as a (meth)acryloyl group, an epoxy group and an oxetanyl group as a reactive functional group. Specific examples of the curable resins include (meth)acrylic ester, a partial epoxy (meth)acrylate resin, and an epoxy resin.

The above-mentioned (meth)acrylic ester includes, for example, ester compounds obtained by reacting (meth)acrylic acid with a compound having a hydroxyl group, epoxy (meth)acrylate obtained by reacting (meth)acrylic acid with an epoxy compound, and urethane (meth)acrylate obtained by reacting isocyanate with a (meth)acrylic acid derivative having a hydroxyl group.

The above-mentioned ester compound obtained by reacting (meth)acrylic acid with a compound having a hydroxyl group is not particularly limited, and examples of a monofunctional compound of the ester compound include 2-hydroxyethyl acrylate, 2-hydroxypropyl (meth)acrylate, 4-hydroxybutyl (meth)acrylate, 2-hydroxybutyl (meth)acrylate, isobutyl (meth)acrylate, tert-butyl (meth)acrylate, isooctyl (meth)acrylate, lauryl (meth)acrylate, stearyl (meth)acrylate, isobornyl (meth)acrylate, cyclohexyl (meth)acrylate, 2-methoxyethyl (meth)acrylate, methoxyethylene glycol (meth)acrylate, 2-ethoxyethyl (meth)acrylate, tetrahydrofurfuryl (meth)acrylate, benzyl (meth)acrylate, ethylcarbitol (meth)acrylate, phenoxyethyl (meth)acrylate, phenoxydiethylene glycol (meth)acrylate, phenoxypolyethylene glycol (meth)acrylate, methoxypolyethylene glycol (meth)acrylate, 2,2,2-trifluoroethyl (meth)acrylate, 2,2,3,3-tetrafluoropropyl (meth)acrylate, 1H,1H,5H-octafluoropentyl (meth)acrylate, imide (meth)acrylate, methyl (meth)acrylate, ethyl (meth)acrylate, n-butyl (meth)acrylate, propyl (meth)acrylate, n-butyl (meth)acrylate, cyclohexyl (meth)acrylate, 2-ethylhexyl (meth)acrylate, n-octyl (meth)acrylate, isononyl (meth)acrylate, isomyristyl (meth)acrylate, 2-butoxyethyl (meth)acrylate, 2-phenoxyethyl (meth)acrylate, bicyclopentenyl (meth)acrylate, isodecyl (meth)acrylate, diethylaminoethyl (meth)acrylate, dimethylaminoethyl (meth)acrylate, 2-(meth)acryloyloxyethyl succinate, 2-(meth)acryloyloxyethyl hexahydrophthalate, 2-(meth)acryloyloxyethyl 2-hydroxypropyl phthalate, glycidyl (meth)acrylate, and 2-(meth)acryloyloxyethyl phosphate.

Further, examples of a bifunctional compound of the ester compound include 1.4-butanediol di(meth)acrylate, 1.3-butanediol di(meth)acrylate, 1,6-hexanediol di(meth)acrylate, 1,9-nonanediol di(meth)acrylate, 1,10-decanediol di(meth)acrylate, 2-n-butyl-2-ethyl-1,3-propanediol di(meth)acrylate, dipropylene glycol di(meth)acrylate, tripropylene glycol di(meth)acrylate, polypropylene glycol (meth)acrylate, ethylene glycol di(meth)acrylate, diethylene glycol di(meth)acrylate, tetraethylene glycol di(meth)acrylate, polyethylene glycol di(meth)acrylate, propylene oxide adduct of bisphenol A di(meth)acrylate, ethylene oxide adduct of bisphenol A di(meth)acrylate, ethylene oxide adduct of bisphenol F di(meth)acrylate, dimethylol-dicyclopentadien di(meth)acrylate, 1,3-butylene glycol di(meth)acrylate, neopentyl glycol di(meth)acrylate, ethylene oxide modified di(meth)acrylate isocyanulate, 2-hydroxy-3-(meth)acryloyloxypropyl (meth)acrylate, carbonatediol di(meth)acrylate, polyetherdiol di(meth)acrylate, polyesterdiol di(meth)acrylate, polycaprolactonediol di(meth)acrylate, and polybutadiendiol di(meth)acrylate.

Further, examples of a trifunctional or higher functional compound of the ester compound include pentaerythritol tri(meth)acrylate, trimethylolpropane tri(meth)acrylate, propylene oxide adduct of trimethylolpropane tri(meth)acrylate, ethylene oxide adduct of trimethylolpropane tri(meth)acrylate, caprolactone modified trimethylolpropane tri(meth)acrylate, ethylene oxide adduct of tri(meth)acrylate isocyanurate, dipentaerythritol penta(meth)acrylate, dipentaerythritol hexa(meth)acrylate, ditrimethylolpropane tetra(meth)acrylate, pentaerythritol tetra(meth)acrylate, glycerin tri(meth)acrylate, propylene oxide adduct of glycerin tri(meth)acrylate, and tris(meth)acryloyloxyethyl phosphate.

The above-mentioned epoxy (meth)acrylate prepared by reacting (meth)acrylic acid with an epoxy compound is not particularly limited and includes, for example, a substance obtained by reacting an epoxy resin with (meth)acrylic acid in the presence of a basic catalyst according to a ordinary method.

An epoxy compound to be a raw material for synthesizing the above-mentioned epoxy (meth)acrylate is not particularly limited, and examples of a commercially available product include bisphenol A type epoxy resins such as EPIKOTE 828EL and EPIKOTE 1004 (all produced by Japan Epoxy Resins Co., Ltd.); bisphenol F type epoxy resins such as EPIKOTE 806 and EPIKOTE 4004 (all produced by Japan Epoxy Resins Co., Ltd.), and EPICLON 830CRP (produced by DAINIPPON INK AND CHEMICALS, INCORPORATED); bisphenol S type epoxy resins such as EPICLON EXA 1514 (produced by DAINIPPON INK AND CHEMICALS, INCORPORATED); 2,2′-diallyl bisphenol A type epoxy resins such as RE-810 NM (produced by Nippon Kayaku Co., Ltd.); hydrogenated bisphenol type epoxy resins such as EPICLON EXA 7015 (produced by DAINIPPON INK AND CHEMICALS, INCORPORATED); propylene oxide adducts of bisphenol A type epoxy resins such as EP-4000S (produced by Asahi Denka Kogyo K.K.); resorcinol type epoxy resins such as EX-201 (produced by Nagase ChemteX Corporation); biphenyl type epoxy resins such as EPIKOTE YX-4000H (produced by Japan Epoxy Resins Co., Ltd.); sulfide type epoxy resins such as YSLV-50TE (produced by Tohto Kasei Co., Ltd.); ether type epoxy resins such as YSLV-80DE (produced by Tohto Kasei Co., Ltd.); dicyclopentadiene type epoxy resins such as EP-4088S (produced by Asahi Denka Kogyo K.K.); naphthalene type epoxy resins such as EPICLON HP-4032, and EPICLON EXA-4700 (all produced by DAINIPPON INK AND CHEMICALS, INCORPORATED); phenol novolac type epoxy resins such as EPICLON N-770 (produced by DAINIPPON INK AND CHEMICALS, INCORPORATED); o-cresol novolac type epoxy resins such as EPICLON N-670-EXP-S (produced by DAINIPPON INK AND CHEMICALS, INCORPORATED); dicyclopentadiene novolac type epoxy resins such as EPICLON HP7200 (produced by DAINIPPON INK AND CHEMICALS, INCORPORATED); biphenyl novolac type epoxy resins such as NC-3000P (produced by produced by Nippon Kayaku Co., Ltd.); naphthalene phenol novolac type epoxy resins such as ESN-165S (produced by Tohto Kasei Co., Ltd.); glycidylamine type epoxy resins such as EPIKOTE 630 (produced by Japan Epoxy Resins Co., Ltd.), EPICLON 430 (produced by DAINIPPON INK AND CHEMICALS, INCORPORATED), and TETRAD-X (produced by Mitsubishi Gas Chemical Company Inc.); alkylpolyol type epoxy resins such as ZX-1542 (produced by Tohto Kasei Co., Ltd.), EPICLON 726 (produced by DAINIPPON INK AND CHEMICALS, INCORPORATED), EPOLIGHT 80MFA (produced by KYOEISHA CHEMICAL Co., Ltd.) and Denacol EX-611 (produced by Nagase ChemteX Corporation); rubber modified type epoxy resins such as YR-450, YR-207 (all produced by Tohto Kasei Co., Ltd.) and EPOLEAD PB (produced by DAICEL CHEMICAL INDUSTRIES, LTD.); glycidyl ester compounds such as Denacol EX-147 (produced by Nagase ChemteX Corporation); bisphenol A type episulfide resins such as EPIKOTE YL-7000 (produced by Japan Epoxy Resins Co., Ltd.); and other resins such as YDC-1312, YSLV-80XY and YSLV-90CR (all produced by Tohto Kasei Co., Ltd.), XAC 4151 (produced by Asahi Kasei Corporation), EPIKOTE 1031 and EPIKOTE 1032 (all produced by Japan Epoxy Resins Co., Ltd.), EXA-7120 (produced by DAINIPPON INK AND CHEMICALS, INCORPORATED), and TEPIC (Nissan Chemical Industries, Ltd.). The above-mentioned epoxy (meth)acrylate obtained by reacting (meth)acrylic acid with an epoxy compound can be obtained, specifically for example, by reacting a mixture of 360 parts by weight of a resorcinol type epoxy resin (EX-201, produced by Nagase ChemteX Corporation), 2 parts by weight of p-methoxyphenol as a polymerization inhibitor, 2 parts by weight of triethylamine as a reaction catalyst and 210 parts by weight of acrylic acid at 90° C. for 5 hours under reflux and stirring while feeding air.

Further, examples of commercially available articles of the above-mentioned epoxy (meth)acrylate include Ebecryl 3700, Ebecryl 3600, Ebecryl 3701, Ebecryl 3703, Ebecryl 3200, Ebecryl 3201, Ebecryl 3600, Ebecryl 3702, Ebecryl 3412, Ebecryl 860, Ebecryl RDX63182, Ebecryl 6040 and Ebecryl 3800 (all produced by DAICEL-CYTEC Company, Ltd.), EA-1020, EA-1010, EA-5520, EA-5323, EA-CHD and EMA-1020 (all produced by SHIN-NAKAMURA CHEMICAL Co., Ltd.), EPOXY-ESTER M600A, EPOXY-ESTER 40EM, EPOXY-ESTER 70PA, EPOXY-ESTER 200PA, EPOXY-ESTER 80MFA, EPOXY-ESTER 3002M, EPOXY-ESTER 3002A, EPOXY-ESTER 1600A, EPOXY-ESTER 3000M, EPOXY-ESTER 3000A, EPOXY-ESTER 200EA and EPOXY-ESTER 400EA (all produced by KYOEISHA CHEMICAL Co., Ltd.), and Denacol Acrylate DA-141, Denacol Acrylate DA-314 and Denacol Acrylate DA-911 (all produced by Nagase ChemteX Corporation).

The above-mentioned urethane (meth)acrylate obtained by reacting isocyanate with a (meth)acrylic acid derivative having a hydroxyl group can be obtained, for example, by reacting one equivalent of a compound having two isocyanate groups with two equivalents of a (meth)acrylic acid derivative having a hydroxyl group in the presence of a catalytic amount of tin-based compound.

Isocyanate to be a raw material of the above-mentioned urethane (meth)acrylate obtained by reacting isocyanate with a (meth)acrylic acid derivative having a hydroxyl group is not particularly limited and includes, for example, isophorone diisocyanate, 2,4-tolylene diisocyanate, 2,6-tolylene diisocyanate, hexamethylene diisocyanate, trimethylhexamethylene diisocyanate, diphenylmethane-4,4′-diisocyanate (MDI), hydrogenated MDI, polymeric MDI, 1,5-naphthalene diisocyanate, norbornanediisocyanate, tolidine diisocyanate, xylylene diisocyanate (XDI), hydrogenated XDI, lysine diisocyanate, triphenylmethane triisocyanate, tris(isocyanatophenyl)thiophosphate, tetramethylxylene diisocyanate, and 1,6,10-undecane triisocyanate.

Further, an isocyanate to be a raw material of the above-mentioned urethane (meth)acrylate obtained by reacting isocyanate with a (meth)acrylic acid derivative having a hydroxyl group is not particularly limited and includes, for example, isocyanate compounds having an extended chain, which are obtained by reactions of polyols such as ethylene glycol, glycerin, sorbitol, trimethylolpropane, (poly)propylene glycol, carbonatediol, polyetherdiol, polyesterdiol and polycaprolactonediol with excessive isocyanate, can also be used.

A (meth)acrylic acid derivative having a hydroxyl group to be a raw material of the above-mentioned urethane (meth)acrylate obtained by reacting isocyanate with the (meth)acrylic acid derivative having a hydroxyl group is not particularly limited and includes, for example commercially available articles such as 2-hydroxyethyl (meth)acrylate, 2-hydroxypropyl (meth)acrylate, 4-hydroxybutyl (meth)acrylate and 2-hydroxybutyl (meth)acrylate, mono-(meth)acrylates of dihydric alcohol such as ethylene glycol, propylene glycol, 1,3-propanediol, 1,3-butanediol, 1,4-butanediol and polyethylene glycol, mono-(meth)acrylates or di-(meth)acrylates of trihydric alcohol such as trimethylolethane, trimethylolpropane and glycerin, and epoxy acrylates such as bisphenol A modified epoxy acrylate.

The above-mentioned urethane (meth)acrylate obtained by reacting isocyanate with a (meth)acrylic acid derivative having a hydroxyl group can be obtained, specifically for example, by adding 134 parts by weight of trimethylolpropane, 0.2 parts by weight of BHT as a polymerization inhibitor, 0.01 parts by weight of dibutyltin dilaurate as a reaction catalyst, and 666 parts by weight of isophorone diisocyanate, and reacting the resulting mixture at 60° C. for 2 hours under reflux while stirring the mixture, and next, adding 51 parts by weight of 2-hydroxyethyl acrylate, and reacting the resulting mixture at 90° C. for 2 hours under reflux and stirring while feeding air.

Examples of commercially available articles of the above-mentioned urethane (meth)acrylate include M-1100, M-1200, M-1210 and M-1600 (all produced by TOAGOSEI CO., LTD.), Ebecryl 230, Ebecryl 270, Ebecryl 4858, Ebecryl 8402, Ebecryl 8804, Ebecryl 8803, Ebecryl 8807, Ebecryl 9260, Ebecryl 1290, Ebecryl 5129, Ebecryl 4842, Ebecryl 210, Ebecryl 4827, Ebecryl 6700, Ebecryl 220 and Ebecryl 2220 (all produced by DAICEL-CYTEC Company, Ltd.), ARTRESIN UN-9000H, ARTRESIN UN-9000A, ARTRESIN UN-7100, ARTRESIN UN-1255, ARTRESIN UN-330, ARTRESIN UN-3320HB, ARTRESIN UN-1200TPK and ARTRESIN SH-500B (all produced by Negami Chemical Industrial Co., Ltd.), U-122P, U-108A, U-340P, U-4HA, U-6HA, U-324A, U-15HA, UA-5201P, UA-W2A, U-1084A, U-6LPA, U-2HA, U-2PHA, UA-4100, UA-7100, UA-4200, UA-4400, UA-340P, U-3HA, UA-7200, U-2061BA, U-10H, U-122A, U-340A, U-108, U-6H and UA-4000 (all produced by SHIN-NAKAMURA CHEMICAL Co., Ltd.), AH-600, AT-600, UA-306H, AI-600, UA-101T, UA-101I, UA-306T and UA 306I.

Examples of the above-mentioned partial epoxy (meth)acrylate resin include a compound obtained by reacting a part of epoxy groups of a compound having two or more epoxy groups with (meth)acrylic acid, and a compound obtained by reacting bifunctional or higher functional isocyanate with a (meth)acrylic acid derivative having a hydroxyl group and glycidol.

Examples of the above-mentioned compound obtained by reacting a part of epoxy groups of a compound having two or more epoxy groups with (meth)acrylic acid include, for example, a substance obtained by reacting an epoxy resin with (meth)acrylic acid in the presence of a basic catalyst according to a normal method.

In this case, as for the amounts of the above-mentioned epoxy resin and (meth)acrylic acid to be mixed, preferably, a lower limit of the equivalent of carboxylic acid is 0.1 equivalents and an upper limit is 0.5 equivalents with respect to one equivalent of an epoxy group, and more preferably, the lower limit of the equivalent of carboxylic acid is 0.2 equivalents and the upper limit is 0.4 equivalents with respect to one equivalent of an epoxy group.

Examples of an epoxy compound to be a raw material of the above-mentioned compound obtained by reacting a part of epoxy groups of a compound having two or more epoxy groups with (meth)acrylic acid include the same compound as the epoxy compound to be a raw material for synthesizing the above-mentioned epoxy (meth)acrylate describe above.

The above-mentioned compound obtained d by reacting a part of epoxy groups of a compound having two or more epoxy groups with (meth)acrylic acid can be obtained, specifically for example, by reacting a mixture of 1000 parts by weight of a phenol novolac type epoxy resin (produced by Dow Chemical Company: D.E.N. 431), 2 parts by weight of p-methoxyphenol as a polymerization inhibitor, 2 parts by weight of triethylamine as a reaction catalyst and 200 parts by weight of acrylic acid at 90° C. for 5 hours under reflux and stirring while feeding air (in this case, 50% of the epoxy resin is partially acrylated).

Examples of commercially available articles of the above-mentioned compounds obtained by reacting a part of epoxy groups of a compound having two or more epoxy groups with (meth)acrylic acid include Ebecryl 1561 (produced by DAICEL-CYTEC Company, Ltd.).

The above-mentioned compound obtained by reacting bifunctional or higher functional isocyanate with a (meth)acrylic acid derivative having a hydroxyl group and glycidol can be obtained, for example, by reacting one equivalent of a compound having two isocyanate groups with one equivalent of a (meth)acrylic acid derivative having a hydroxyl group and one equivalent of glycidol in the presence of a catalytic amount of tin-based compound.

Examples of a bifunctional or higher functional isocyanate to be a raw material of the above-mentioned compound obtained by reacting bifunctional or higher functional isocyanate with a (meth)acrylic acid derivative having a hydroxyl group and glycidol is not particularly limited and include, for example, the same compound as the isocyanate to be a raw material of the above-mentioned urethane (meth)acrylate obtained by reacting the isocyanate with a (meth)acrylic acid derivative having a hydroxyl group.

Examples of a (meth)acrylic acid derivative having a hydroxyl group to be a raw material of the above-mentioned compound obtained by reacting bifunctional or higher functional isocyanate with a (meth)acrylic acid derivative having a hydroxyl group and glycidol is not particularly limited and include, for example, the same compound as the (meth)acrylic acid derivative having a hydroxyl group to be a raw material of the above-mentioned urethane (meth)acrylate obtained by reacting the isocyanate with a (meth)acrylic acid derivative having a hydroxyl group.

The above-mentioned compound obtained by reacting bifunctional or higher functional isocyanate with a (meth)acrylic acid derivative having a hydroxyl group and glycidol can be obtained, specifically for example, by adding 134 parts by weight of trimethylolpropane, 0.2 parts by weight of BHT as a polymerization initiator, 0.01 parts by weight of dibutyltin dilaurate as a reaction catalyst, and 666 parts by weight of isophorone diisocyanate, and reacting the resulting mixture at 60° C. for 2 hours under reflux while stirring the mixture, and next, adding 25.5 parts by weight of 2-hydroxyethyl acrylate and 111 parts by weight of glycidol, and reacting the resulting mixture at 90° C. for 2 hours under reflux and stirring while feeding air.

The above-mentioned epoxy resin is not particularly limited and includes, for example, epichlorohydrin derivatives, alicyclic epoxy resins, and compounds obtained by the reaction of isocyanate with glycidol.

Examples of the above-mentioned epichlorohydrin derivatives include bisphenol A type epoxy resins such as EPIKOTE 828EL and EPIKOTE 1004 (all produced by Japan Epoxy Resins Co., Ltd.); bisphenol F type epoxy resins such as EPIKOTE 806 and EPIKOTE 4004 (all produced by Japan Epoxy Resins Co., Ltd.); bisphenol S type epoxy resins such as EPICLON EXA 1514 (produced by DAINIPPON INK AND CHEMICALS, INCORPORATED); 2,2′-diallyl bisphenol A type epoxy resins such as RE-810 NM (produced by produced by Nippon Kayaku Co., Ltd.); hydrogenated bisphenol type epoxy resins such as EPICLON EXA 7015 (produced by DAINIPPON INK AND CHEMICALS, INCORPORATED); propylene oxide adducts of bisphenol A type epoxy resins such as EP-4000S (produced by Asahi Denka Kogyo K.K.); resorcinol type epoxy resins such as EX-201 (produced by Nagase ChemteX Corporation); biphenyl type epoxy resins such as EIKOTE YX-4000H (produced by Japan Epoxy Resins Co., Ltd.); sulfide type epoxy resins such as YSLV-50TE (produced by Tohto Kasei Co., Ltd.); ether type epoxy resins such as YSLV-80DE (produced by Tohto Kasei Co., Ltd.); dicyclopentadiene type epoxy resins such as EP-4088S (produced by Asahi Denka Kogyo K.K.); naphthalene type epoxy resins such as EPICLON HP-4032 and EPICLON EXA-4700 (all produced by DAINIPPON INK AND CHEMICALS, INCORPORATED); phenol novolac type epoxy resins such as EPICLON N-770 (produced by DAINIPPON INK AND CHEMICALS, INCORPORATED); o-cresol novolac type epoxy resins such as EPICLON N-670-EXP-S (produced by DAINIPPON INK AND CHEMICALS, INCORPORATED); dicyclopentadiene novolac type epoxy resins such as EPICLON HP-7200 (produced by DAINIPPON INK AND CHEMICALS, INCORPORATED); biphenyl novolac type epoxy resins such as NC-3000P (produced by produced by Nippon Kayaku Co., Ltd.); naphthalene phenol novolac type epoxy resins such as ESN-165S (produced by Tohto Kasei Co., Ltd.); glycidylamine type epoxy resins such as EPIKOTE 630 (produced by Japan Epoxy Resins Co., Ltd.), EPICLON 430 (produced by DAINIPPON INK AND CHEMICALS, INCORPORATED), and TETRAD-X (produced by Mitsubishi Gas Chemical Company Inc.); alkylpolyol type epoxy resins such as ZX-1542 (produced by Tohto Kasei Co., Ltd.), EPICLON 726 (produced by DAINIPPON INK AND CHEMICALS, INCORPORATED), EPOLIGHT 80MFA (produced by KYOEISHA CHEMICAL Co., Ltd.) and Denacol EX-611 (produced by Nagase ChemteX Corporation); rubber modified type epoxy resins such as YR-450, YR-207 (all produced by Tohto Kasei Co., Ltd.) and EPOLEAD PB (produced by DAICEL CHEMICAL INDUSTRIES, LTD.); glycidyl ester compounds such as Denacol EX-147 (produced by Nagase ChemteX Corporation); bisphenol A type episulfide resins such as EPIKOTE YL-7000 (produced by Japan Epoxy Resins Co., Ltd.); and other resins such as YDC-1312, YSLV-80XY and YSLV-90CR (all produced by Tohto Kasei Co., Ltd.), XAC 4151 (produced by Asahi Kasei Corporation), EPIKOTE 1031 and EPIKOTE 1032 (all produced by Japan Epoxy Resins Co., Ltd.), EXA-7120 (produced by DAINIPPON INK AND CHEMICALS, INCORPORATED), and TEPIC (produced by Nissan Chemical Industries, Ltd.).

Further, the above-mentioned alicyclic epoxy resin is not particularly limited, and examples of commercially available articles of the alicyclic epoxy resin include CELLOXIDE 2021, CELLOXIDE 2080, CELLOXIDE 3000, EPOLEAD GT300, and EHPE (all produced by DAICEL CHEMICAL INDUSTRIES, LTD.).

The above-mentioned compound obtained by the reaction of isocyanate with glycidol is not particularly limited and include and can be obtained, for example, by reacting a compound having two isocyanate groups with two equivalents of glycidol in the presence of a tin-based compound as a catalytic.

The above-mentioned isocyanate is not particularly limited and include, for example, isophorone diisocyanate, 2,4-tolylene diisocyanate, 2,6-tolylene diisocyanate, hexamethylene diisocyanate, trimethylhexamethylene diisocyanate, diphenylmethane-4,4′-diisocyanate (MDI), hydrogenated MDI, polymeric MDI, 1,5-naphthalene diisocyanate, norbornanediisocyanate, tolidine diisocyanate, xylylene diisocyanate (XDI), hydrogenated XDI, lysine diisocyanate, triphenylmethane triisocyanate, tris(isocyanatephenyl)thiophosphate, tetramethylxylene diisocyanate, and 1,6,10-undecane triisocyanate.

Further, as the above-mentioned isocyanate, for example, isocyanate compounds having an extended chain, which are obtained by reactions of polyols such as ethylene glycol, glycerin, sorbitol, trimethylolpropane, (poly)propylene glycol, carbonatediol, polyetherdiol, polyesterdiol and polycaprolactonediol with excessive isocyanate, can also be used.

Examples of a synthetic method of the above compounds obtained by the reaction of isocyanate with glycidol include, specifically for example, a method in which 134 parts by weight of trimethylolpropane, 0.01 parts by weight of dibutyltin dilaurate as a reaction catalyst, and 666 parts by weight of isophorone diisocyanate are added, and the resulting mixture is reacted at 60° C. for 2 hours under reflux while stirring the mixture, and next, 222 parts by weight of glycidol is added, and the resulting mixture is reacted at 90° C. for 2 hours under reflux and stirring while feeding air.

In the sealant of the first present invention, the above-mentioned curable resin is preferably a compound having two or more reactive groups in a molecule in order to reduce a portion remaining without being cured in curing as much as possible.

Further, in order to more inhibit the component of the sealant of the first present invention from eluting into a liquid crystal before curing the sealant, the above-mentioned curable resin preferably has at least one functional group capable of coupling with hydrogen in a molecule.

The above-mentioned functional group capable of coupling with hydrogen is not particularly limited and include, for example, functional groups such as —OH group, —SH group, —NHR group (R represents aromatic or aliphatic hydrocarbons and derivatives thereof), —COOH group and —NHOH group, and residues such as —NHCO—, —NH—, —CONHCO— and —NH—NH—, and among others, —OH group is preferred from the viewpoint of ease of introduction.

Further, the sealant of the first present invention preferably contains a photopolymerization initiator. The above-mentioned photopolymerization initiator is not particularly limited and includes, for example, benzophenone, 2,2-diethoxyacetophenone, benzyl, benzoin isopropyl ether, benzyl dimethyl ketal, 1-hydroxycyclohexylphenyl ketone, thioxanthone, and KR-02 (produced by Light Chemical Industries Co., Ltd.). These photopolymerization initiators may be used alone or in combination of two or more species.

Examples of commercially available articles of the above-mentioned photopolymerization initiators include IRGACURE 907, IRGACURE 819, IRGACURE 651 and IRGACURE 369 (all produced by Ciba Specialty Chemicals K.K.), benzoin methyl ether, benzoin ethyl ether, benzoin isopropyl ether and Lucirin TPO (produced by BASF Japan Ltd.) Among others, initiators having a molar absorption coefficient of 100 M⁻¹ cm⁻¹ or more at 350 nm, measured in acetonitrile, of IRGACURE 907, IRGACURE 651, BIPE and Lucirin TPO are suitable.

With respect to the content of the above-mentioned photopolymerization initiator, a lower limit is 0.1 parts by weight, and an upper limit is 10 parts by weight, with respect to 100 parts by weight of the total of the (meth)acrylate compound having the structure expressed by the general formula (1) described above and the curable resin. When the content of the photopolymerization initiator is less than 0.1 parts by weight, the above-mentioned effects of the present invention are not produced because of the insufficient ability to initiate the photopolymerization, and when the content is more than 10 parts by weight, an unreacted radical polymerization initiator remains in large quantity and therefore the weather resistance of the sealant of the present invention becomes low. More preferably, the lower limit is 1 part by weight and the upper limit is 5 parts by weight.

The sealant of the first present invention may further contain a radical polymerization initiator to produce an activated radical by irradiation of light, which the sealant of the second present invention described below contains, in addition to the above-mentioned photopolymerization initiator.

Further, the sealant of the first present invention preferably contains a radical polymerization initiator having three or more ring structures in a molecule.

Since such a radical polymerization initiator having three or more ring structures in a molecule has a robust molecular structure, it has low volatility compared with the radical polymerization initiator used in the production of liquid crystal display devices by a conventional One prop Fill process, and therefore the above-mentioned radical polymerization initiator having three or more ring structures in a molecule becomes hard to diffuse in the sealant when a liquid crystal display device is produced by a One prop Fill process using the sealant of the first present invention. In addition, in the present description, a ring structure refers to a ring structure in which number of constituent atoms is five or more, such as a benzene ring, a cyclohexane ring and a morpholine ring.

The above-mentioned radical polymerization initiators having three or more ring structures in a molecule is not particularly limited and include, for example 4-phenylbenzophenone, 4-benzoyl-4′-methyl diphenyl sulfide and 2,2-bis(2-chlorophenyl)-4,5,4′,5′-tetraphenyl-2′-H-(1,2′)biimidazole.

Examples of commercially available articles of these radical polymerization initiators having three or more ring structures in a molecule include IRGACURE 369, IRGACURE 819 and IRGACURE TPO (all produced by Ciba Specialty Chemicals K.K.), and Speedcure BCIM (produced by Lambson).

The above-mentioned radical polymerization initiators having three or more ring structures in a molecule preferably has a lower limit of a molar absorption coefficient of 200 M⁻¹ cm⁻¹ at 350 nm, measured in acetonitrile. When the molar absorption coefficient is less than 200 M⁻¹·cm⁻¹, the curability of the above-mentioned curable resin may be deteriorated, and the radical polymerization initiator having three or more ring structures in a molecule may diffuse into a liquid crystal when a liquid crystal display device is produced by a One prop Fill process using the sealant of the first present invention.

Examples of a radical polymerization initiator having three or more ring structures in a molecule, which has such a molar absorption coefficient, include IRGACURE 369, IRGACURE 819, and IRGACURE TPO (all produced by Ciba Specialty Chemicals K.K.).

The sealant of the first present invention may contain a thermally curing agent. The above-mentioned thermally curing agent is not particularly limited and include, for example hydrazide compounds such as 1,3-bis[hydrazinocarbonoethyl-5-isopropylhydantoin], dicyandiamide, guanidine derivatives, imidazole derivatives such as 1-cyanoethyl-2-phenylimidazole, N-[2-(2-methyl-1-imidazolyl)ethyl]urea, 2,4-diamino-6-[2′-methylimidazolyl-(1′)]-ethyl-s-triazine, N,N′-bis(2-methyl-1-imidazolylethyl)urea, N,N′-(2-methyl-1-imidazolylethyl)-adipamide, 2-phenyl-4-methyl-5-hydroxymethylimidazole and 2-phenyl-4,5-dihydroxymethylimidazole, modified aliphatic polyamine, acid anhydride such as tetrahydrbphthalic anhydride, ethylene glycol-bis(anhydrotrimellitate), and addition products of various amines and an epoxy resin. These compounds may be used alone or in combination of two or more species. Among others, hydrazide compounds are preferably used.

As the above-mentioned thermally curing agent, a latent curing agent having a melting point of 100° C. or higher is suitably used. When a curing agent having a melting point of 100° C. or lower is used, storage stability may be significantly deteriorated.

A preferred lower limit of an amount of the above-mentioned thermally curing agent to be mixed is 1 part by weight, and a preferred upper limit is 60 parts by weight with respect to 100 parts by weight of the total of the (meth)acrylate compound having the structure expressed by the above general formula (1) and the curable resin. When the amount of the thermally curing agent to be mixed is out of this range, the adhesion of a cured substance is deteriorated and the deterioration of liquid crystal properties in a high-temperature and high-humidity operation test may be hastened. More preferably, the lower limit is 5 parts by weight and the upper limit is 50 parts by weight.

The sealant for a One prop Fill process of the second present invention (hereinafter, also simply referred to as a sealant of the second present invention) contains a curable resin.

As for the above-mentioned curable resin, in the sealant of the second present invention, 60 mol % or more of the reactive functional groups contained in the above curable resin are (meth)acryloyl groups.

Incidentally, in the present discriprion, a “reactive functional group” refers to cyclic ethers such as a (meth)acryloyl group, an epoxy group and an oxetanyl group and styryl groups, and a (meth)acryloyl group means an acryloyl group or a methacryloyl group.

In the sealant of the second present invention, examples of the above-mentioned curable resins include the same substances as the (meth)acrylate compound having a structure expressed by the general formula (1) and the curable resin in the sealant of the first present invention described above.

Herein, the description that 60 mol % or more of the reactive functional groups contained in the above curable resin are (meth)acryloyl groups refers to that when the above-mentioned curable resin is a mixed resin formed by appropriately blending, for example, the above (meth)acrylic ester, a partial epoxy (meth)acrylate resin, and an epoxy resin, the proportion of a (meth)acryloyl group is 60 mol % or more of the total amount of the reactive functional group in the mixed resin.

When the proportion of the above-mentioned (meth)acryloyl group is less than 60 mol % of the reactive functional groups contained in the above curable resin, curing by light irradiation is not adequate and liquid crystal contamination is produced. A preferred lower limit of the proportion of the (meth)acryloyl group is 75 mol %.

Further, In the sealant of the second present invention, it is preferred to mix a compound having, for example, at least one epoxy group and at least one (meth)acryloyl group in a molecule as the above curable resin.

Further, the above-mentioned curable resin preferably has two or more reactive functional groups in a molecule of the curable resin in order to minimize an unreacted resin remaining after curing. By falling within this range, an unreacted compound remaining after polymerization or a crosslinking reaction becomes extremely low, and liquid crystal contamination does not occur when a liquid crystal display device is produced using the sealant of the second present invention.

Further, in the above-mentioned curable resin, a preferred upper limit of number of the reactive functional groups in a molecule is 6. When the number of the reactive functional groups is more than 6, shrinkage due to curing becomes large and this may result in reduction in adhesive force. More preferably, the lower limit is 2 and the upper limit is 4.

In the sealant of the second present invention, the above-mentioned curable resin preferably has a functional group capable of coupling with hydrogen in a molecule from the viewpoint of the reduction in the elution of resin components into a liquid crystal, and more preferably has a hydroxyl group or a urethane bond.

The sealant of the second present invention contains a radical polymerization initiator to produce an activated radical by irradiation of light.

The above-mentioned radical polymerization initiator has a lower limit of a molar absorption coefficient of 100 M⁻¹·cm⁻¹ at 350 nm, measured in acetonitrile and an upper limit of a molar absorption coefficient of 100000 M⁻¹·cm⁻¹. When the molar absorption coefficient is less than 100 M⁻¹ cm⁻¹, if the irradiation of ultraviolet light to some area is blocked by a black matrix (BM) or the like, it becomes impossible to cure quickly and adequately this area. When the molar absorption coefficient is more than 100000 M⁻¹·cm⁻¹, in irradiating ultraviolet light the surface of a portion directly irradiated with ultraviolet light is cured first, and therefore the internal of this portion cannot be adequately cured, and an area, ultraviolet light to which is blocked by the BM or the like, cannot also be cured.

Preferably, the lower limit of a molar absorption coefficient is 200 M⁻¹·cm⁻¹ and the upper limit is 10000 M⁻¹·cm⁻¹, and more preferably, the lower limit of a molar absorption coefficient is 300 M⁻¹·cm⁻¹ and the upper limit is 3000 M⁻¹·cm⁻¹.

The above-mentioned radical polymerization initiator preferably has a molar absorption coefficient of 100 M⁻¹ cm⁻¹, or less at 450 nm, measured in acetonitrile. When the molar absorption coefficient is more than 100 M⁻¹·cm⁻¹, handling of the sealant of the second present invention becomes highly inconvenient since an activated radical is produced by light with a wavelength in the visible light region.

In addition, in the present description, the above-mentioned molar absorption coefficient refers to a value of ε (M⁻¹·cm⁻¹) defined by Lambert-Beer equation on an acetonitrile solution including the above-mentioned radical polymerization initiator, shown in the following equation (1):

[Mathematical formula 1]

log(I₀/I)=εcd (1)

In the formula (1), I represents the intensity of transmitted light, I₀ represents the intensity of transmitted light of a acetonitrile pure solvent, c represents a molar concentration (M), d represents a thickness (cm) of a solution layer, and log(I₀/I) represents absorbance.

The above-mentioned radical polymerization initiator is not particularly limited as long as it satisfies the above-mentioned molar absorption coefficient, and example of the radical polymerization initiator include substances having radical polymerization initiating group such as a carbonyl group, a sulfur-containing group, an azo group and an organic peroxide-containing group, but among others, groups are suitable, which have structures expressed by the following general formulas (5) to (8):

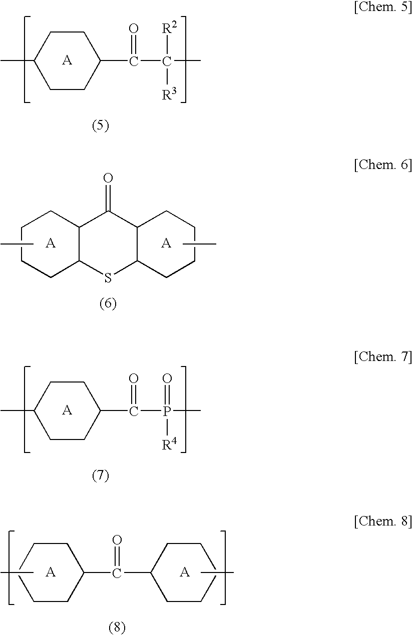

In the formulas (5) to (8), R², R³, and R⁴ each independently represent an alkyl group having 1 to 6 carbon atoms, a hydrogen atom, a hydroxyl group, an alkoxyl group having 1 to 6 carbon atoms, a (meth)acryl group, and a phenyl group, and

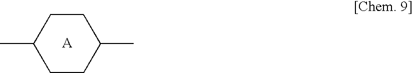

represents an aromatic ring optionally having an alkyl group having 1 to 6 carbon atoms or a halogen group.

Among others, the group having the structure expressed by the above general formula (5) is more preferable from the viewpoint of generation efficiency of activated radicals.

The above-mentioned radical polymerization initiator preferably contains a functional group capable of coupling with hydrogen.

The above-mentioned functional group capable of coupling with hydrogen is not particularly limited as long as it is a functional group or a residue having a property of coupling with hydrogen, and examples of these groups include an OH group, an NH₂ group, an NHR group (R represents aromatic or aliphatic hydrocarbons and derivatives thereof), a COOH group, a CONH₂ group, an NHOH group etc., and groups having a residue such as an NHCO bond, an NH bond, a CONHCO bond or an NH—NH bond in a molecule.

By having such the functional group capable of coupling with hydrogen, the above-mentioned radical polymerization initiator becomes resistant to elution even when an uncured sealant of the second present invention comes into contact with a liquid crystal and liquid crystal contamination hardly occurs further.

Preferably, the above-mentioned radical polymerization initiator further has a reactive functional group which can react with and can be bonded to the above-mentioned curable resin.

The above-mentioned reactive functional group is not particularly limited as long as it is a functional group capable of coupling with the curable resin by a polymerization reaction, and example of the reactive functional group include cyclic ether groups such as an epoxy group and an oxetanyl group, a (meth)acryl group, and a styryl group. Among others, a (meth)acryl group or an epoxy group is preferred.

By having such the reactive functional group in a molecule, since the above-mentioned radical polymerization initiator itself forms a copolymer with the curable resin to be fixed, the residue of the radical polymerization initiator is not eluted into a liquid crystal after the completion of polymerization, and it does not cause outgassing by heating during liquid crystal realignment.

Further, in the radical polymerization initiator in which by irradiation of light, a radical polymerization initiating group is dissociated to produce two activated radicals, if the produced activated radical is deactivated due to hydrogen abstraction before adding to a radically polymerizable functional group such as an (meth)acryl group, the radical polymerization initiator may elute into a liquid crystal or may cause outgassing after curing. Therefore, in the above-mentioned radical polymerization initiator, it is preferred that when the radical polymerization initiating group absorbs light to be dissociated to into two activated radicals, each activated radical has at least one functional group capable of coupling with hydrogen and at least one reactive functional group. That is, it is preferred that the above-mentioned reactive functional group is arranged in a molecule in such a way that when the above radical polymerization initiating group is dissociated to produce two activated radicals by irradiation of light, each activated radical has at least one functional group capable of coupling with hydrogen and at least one reactive functional group. Thereby, since all activated radicals produced form a copolymer with the curable resin to be fixed, the residue of the radical polymerization initiator is not eluted into a liquid crystal after the completion of polymerization, and since the residue of the radical polymerization initiator is incorporated into a cured substance after curing, it does not cause outgassing by heating during liquid crystal realignment.

A preferred lower limit of a number average molecular weight of the above-mentioned radical polymerization initiator is 300. When the number average molecular weight is less than 300, the components of the radical polymerization initiator are eluted into a liquid crystal and this may easily cause alignment defects of liquid crystals. A preferred upper limit is 3000. When the number average molecular weight exceeds 3000, adjustment of the viscosity of the sealant of the second present invention may become difficult.

A method of producing the above-mentioned radical polymerization initiator is not particularly limited and publicly known methods can be employed, and examples of the methods include a method of esterifying an alcohol derivative having the above radical polymerization initiating group and a hydroxyl group in a molecule in (meth)acrylic acid form using (meth)acrylic acid or (meth)acrylic chloride; a method of reacting a compound having the above radical polymerization initiating group, a hydroxyl group or an amino group in a molecule with one epoxy group of a compound having two or more epoxy groups in a molecule; a method in which a compound having two or more above radical polymerization initiating groups, two or more hydroxyl groups or two or more amino group in a molecule is reacted with one epoxy group of a compound having two or more epoxy groups in a molecule, and further the other epoxy group is reacted with (meth)acrylic acid or (meth)acrylic ester monomer, styrene monomer or the like having an activated hydrogen group; a method in which a compound having two or more above radical polymerization initiating groups, two or more hydroxyl groups or two or more amino group in a molecule is reacted with a cyclic ester compound or a carboxylic acid compound having a hydroxyl group, and further the above-mentioned hydroxyl group is esterified in(meth)acrylic acid form; and a method in which an urethane derivative is synthesized from a compound having two or more above radical polymerization initiating groups, two or more hydroxyl groups or two or more amino group in a molecule and a bifunctional isocyanate derivative, and further the other isocyanate is reacted with (meth)acrylic acid, glycidol, or (meth)acrylic ester monomer having a hydroxyl group, styrene monomer or the like.

Examples of the above-mentioned compound having two or more epoxy groups in a molecule include bifunctional epoxy resin compounds.

The above-mentioned bifunctional epoxy resin compounds are not particularly limited and include, for example bisphenol A type epoxy resins, bisphenol F type epoxy resins, bisphenol AD type epoxy resins, hydrogenated epoxy resins of these epoxy resins, novolac type epoxy resins, urethane modified epoxy resins, nitrogen-containing epoxy resins formed by epoxidizing m-xylenediamine or the like, and rubber modified epoxy resins containing polybutadiene, nitrile butadiene rubber (NBR) or the like. These bifunctional epoxy resin compounds may be solid or liquid.

The above-mentioned (meth)acrylic ester monomer having a hydroxyl group is not particularly limited and includes, for example, mono-(meth)acrylates of dihydric alcohol such as ethylene glycol, propylene glycol, 1,3-propanediol, 1,3-butanediol, 1,4-butanediol and polyethylene glycol, and mono-(meth)acrylates or di-(meth)acrylates of trihydric alcohol such as trimethylolethane, trimethylolpropane and glycerin. These compounds may be used alone or in combination of two or more species.

Examples of the above-mentioned bifunctional isocyanate derivative include diphenylmethane diisocyanate (MDI), tolylene diisocyanate (TDI), xylene diisocyanate (XDI), isophorone diisocyanate (IPDI), naphthylene diisocyanate (NDI), tolidine diisocyanate (TPDI), hexamethylene diisocyanate (HDI), dicyclohexylmethane diisocyanate (HMDI), and trimethylhexamethylene diisocyanate (TMHDI). In the sealant of the second present invention, the above-mentioned radical polymerization initiator may be used alone or in combination of two or more species.

A preferred lower limit of an amount of the above-mentioned radical polymerization initiator to be mixed in the sealant of the second present invention is 0.1 parts by weight with respect to 100 parts by weight of the curable resin described above, and a preferred upper limit is 10 parts by weight. If the amount of the above-mentioned radical polymerization initiator to be mixed is less than 0.1 parts by weight, it may be impossible to cure adequately the sealant of the second present invention, and if the amount of the above-mentioned radical polymerization initiator to be mixed exceeds 10 parts by weight, when irradiating light to the sealant of the second present invention, the surface of the sealant is cured first, and therefore the internal of the sealant cannot be adequately cured, and if there is an area, light to which is blocked by the BM or the like, there may be cases where this area cannot be adequately cured. And, curing and storage stability may be deteriorated.

The sealant of the second present invention may contain the photopolymerization initiator described in the sealant of the first present invention described above.

The sealant of the second present invention contains solid organic acid hydrazide. By containing the above-mentioned solid organic acid hydrazide, the curability, based on ultraviolet light irradiation, of the sealant of the second present invention is improved. The reason for this is not clear, but it is conceivable as follows.

That is, it is thought that the solid organic acid hydrazide contained in the sealant of the second present invention scatters the irradiated ultraviolet light in the sealant of the second present invention, and thereby this ultraviolet light penetrates around to an area, irradiated ultraviolet light to which is blocked by the BM or the like, on the backside of the BM, and consequently the curability of the sealant of the second present invention is improved.

The above-mentioned solid organic acid hydrazide is not particularly limited and includes, for example, sebacic dihydrazide, isophthalic dihydrazide, adipic dihydrazide, and in addition AMICURE VDH, AMICURE UDH (both produced by Ajinomoto Fine-Techno Co., Inc.), ADH (produced by Otsuka Chemical Co., Ltd.).

A preferred lower limit of an amount of the above-mentioned solid organic acid hydrazide to be mixed is 1 part by weight with respect to 100 parts by weight of the above-mentioned curable resin, and a preferred upper limit is 50 parts by weight. When the amount of the above-mentioned solid organic acid hydrazide to be mixed is less than 1 part by weight, it has little effect of improving the curability of the sealant of the second present invention by mixing the solid organic acid hydrazide, and when this amount is more than 50 parts by weight, the viscosity of the sealant of the second present invention becomes high and this may impair handling. More preferred upper limit is 30 parts by weight.

Since the above-mentioned solid organic acid hydrazide is generally used for a thermally curing agent of a sealant, if the sealant of the second present invention contains the above-mentioned solid organic acid hydrazide, the solid organic acid hydrazide can act directly as a thermally curing agent to cure the sealant of the second present invention by heat.

Further, the sealant of the second present invention may further contain the thermally curing agent described in the sealant of the first present invention described above.

The sealant of the first present invention and the sealant of the second present invention may further contain a silane coupling agent. The silane coupling agent has a role as an adhesive aid to improve the adhesion to a glass substrate and the like.

The above-mentioned silane coupling agent is not particularly limited, but for example, γ-aminopropyltrimethoxysilane, γ-mercaptopropyltrimethoxysilane, γ-glycidoxypropyltrimethoxysilane, γ-isocyanatepropyltrimethoxysilane etc., and a substance comprising an imidazole silane compound having a structure in which an imidazole skeleton is bonded to an alkoxysilyl group through a spacer group are suitably used because these compounds have an excellent effect of improving the adhesion to a glass substrate and can prevent from eluting into a liquid crystal by chemically bonding to the curable resin. These silane coupling agents may be used alone or in combination of two or more species.

The sealant of the first present invention and the sealant of the second present invention may contain a filler for the purpose of improving the adhesion through stress dispersion effect and improving a coefficient of linear thermal expansion. The above-mentioned filler is not particularly limited and include, for example, inorganic fillers such as talc, asbestos, silica, diatomite, smectite, bentonite, calcium carbonate, magnesium carbonate, alumina, montmorillonite, diatomite, zinc oxide, iron oxide, magnesium oxide, tin oxide, titanium oxide, magnesium hydroxide, aluminum hydroxide, glass beads, silicon nitride, barium sulfate, calcium sulfate, calcium silicate, talc, glass beads, sericite activated clay, bentonite and aluminum nitride, and organic fillers such as polyester particle, polyurethane particle, vinyl polymer particle and acryl polymer particle.

The sealant of the first present invention and the sealant of the second present invention may further contain a reactive diluent for adjusting viscosity, a thixotropic agent for adjusting thixotropy, spacers such as polymer beads for adjusting a panel gap, a curing accelerator such as 3-p-chlorophenyl-1,1-dimethyl urea, an antifoamer, a leveling agent, a polymerization inhibitor and other additives as required.

A method of producing the sealant of the first present invention and the sealant of the second present invention is not particularly limited and include, for example, a method of mixing and dispersing uniformly the above-mentioned curable resins, radical polymerization initiators, and additives etc. to be added as required by publicly known techniques using a three roll or the like. In this time, the sealant may come into contact with ion-adsorptive solid matter such as layered silicate minerals in order to remove ionic impurities.

The sealant of the first present invention hardly causes a peeling phenomenon between the sealant and the substrate in fabrication of liquid crystal display device since the sealant has excellent adhesion to the substrate, and it can be suitably used for the fabrication of a liquid crystal display device having low color irregularity in liquid crystal display since it does not cause liquid crystal contamination.

Since the sealant of the second present invention contains the radical polymerization initiator having a lower limit of a molar absorption coefficient of 100 M⁻¹·cm⁻¹ at 350 nm, measured in acetonitrile, and an upper limit of 100000 M⁻¹·cm⁻¹, and the curable resin in which 60 mol % or more of the reactive functional groups contained in molecules are (meth)acryloyl groups, by irradiating ultraviolet light, it is possible to cure even a portion to which light is not directly irradiated because a part of patterns of the sealant to be formed on a transparent substrate is located at a position overlapping with the black matrix (BM) or a wiring in the thickness direction of a liquid crystal cell. Accordingly, the sealant of the second present invention can be suitably used particularly when a liquid crystal display panel of a narrow picture-frame design is manufactured.

By mixing conductive particles in such the sealant of the first present invention or the sealant of the second present invention, a vertically conducting material can be produced. When such a vertically conducting material is employed, electrodes can be adequately conductively connected to each other even though there is a portion to which light such as ultraviolet light is not directly irradiated.

The vertically conducting material containing the sealant of the first present invention or the sealant of the second present invention, and conductive particles also constitutes the present invention.

The above-mentioned conductive particle is not particularly limited and a metal ball, and a resin particle having a conductive metal layer on the surface can be used. Among others, the resin particle having a conductive metal layer on the surface is suitable because it can be conductively connected without damage to a transparent substrate by virtue of excellent elasticity of a resin particle.

A method of manufacturing liquid crystal display devices by use of the sealant of the first present invention or the sealant of the second present invention and/or the vertically conducting material of the present invention is not particularly limited, and it is possible to manufacture the liquid crystal display devices by, for example, the following methods.

First, the sealant of the first present invention or the sealant of the second present invention and/or the vertically conducting material of the present invention are applied onto one of two transparent substrates with an electrode of an ITO thin film etc. by a screen printing method, a dispenser method or the like to form a rectangular seal pattern. Next, a small droplet of liquid crystal is dispensed and applied to the whole area within a frame of the transparent substrate in a state of keeping the sealant uncured, and on this, the other transparent substrate is immediately overlaid, and ultraviolet light is irradiated to the sealed portion to cure the sealant. When the sealant of the first present invention or the sealant of the second present invention has a thermosetting property, the substrate was further heated for 1 hour in an oven of 100 to 200° C. to cure the sealant completely and prepare a liquid crystal display device.

A liquid crystal display device formed by use of the sealant of the first present invention or the sealant of the second present invention and/or the vertically conducting material of the present invention also constitutes the present invention.

Further, a method of manufacturing the liquid crystal display device of the present invention, namely, a method of manufacturing liquid crystal display devices, comprising at least the steps of applying the sealant of the first present invention or the sealant of the second present invention and/or the vertically conducting material onto one of two transparent substrates with an electrode to form a seal pattern, and dispensing and applying a small droplet of liquid crystal to the whole area within a frame of the transparent substrate in a state of keeping the sealant of the first present invention or the sealant of the second present invention and/or the vertically conducting material of the present invention uncured, overlaying the other transparent substrate immediately, and irradiating ultraviolet light to the sealed portion to cure the sealant, also constitutes the present invention.

### Effects of the Invention

In accordance with the present invention, it is possible to provide a sealant for a One prop Fill process which hardly causes a peeling phenomenon between the sealant and a substrate in fabrication of liquid crystal display device since the sealant has excellent adhesion to the substrate, and which is most suitable for fabricating a liquid crystal display device having low color irregularity in liquid crystal display since the sealant does not cause liquid crystal contamination, and it is possible to provide a sealant for a One prop Fill process, in which in fabrication of liquid crystal display device by a One prop Fill process, even a portion to which light may be not directly irradiated can be adequately cured and high display quality and high reliability of the liquid crystal display device can be realized, a vertically conducting material, and a liquid crystal display device formed by using these materials.

That is, even though there is a portion to which light is not directly irradiated because a part of patterns of the sealant to be formed on a transparent substrate using the sealant of the second present invention is located at a position overlapping with the black matrix (BM) or a wiring or the like in the thickness direction of a liquid crystal cell, this portion can be cured by irradiating ultraviolet light since this ultraviolet light penetrate around to the back of the BM or the like. Such the sealant of the second present invention can be suitably used particularly when a liquid crystal display panel of a narrow picture-frame design is manufactured.

### BEST MODE FOR CARRYING OUT THE INVENTION

Hereinafter, the present invention will be described in more detail by way of examples, but the present invention is not limited to these examples.

### (Synthesis of Curable Resin (A))

Into a reaction flask, 116 parts by weight of 2-hydroxyethyl acrylate, 0.3 parts by weight of p-methoxy phenol as a polymerization inhibitor, and 148 parts by weight of phthalic anhydride were put, and the content of the flask was heated to 90° C. with a mantle heater and stirred for 5 hours.

Subsequently, 170 parts by weight of bisphenol A diglycidyl ether was added and the resulting mixture was stirred at 90° C. for 5 hours to obtain a curable resin (A).

### (Synthesis of Curable Resin (B))

Into a reaction flask, 116 parts by weight of 2-hydroxyethyl acrylate and 217 parts by weight of β-propiolactone were put, and to this, 0.3 parts by weight of p-methoxy phenol as a polymerization inhibitor was added, and the content of the flask was heated to 90° C. with a mantle heater and stirred for 5 hours. To the stirred product, 148 parts by weight of phthalic anhydride was added, and the resulting mixture was further stirred for 5 hours.

Subsequently, 170 parts by weight of bisphenol A diglycidyl ether was added and the resulting mixture was stirred at 90° C. for 5 hours to obtain a curable resin (B).

### (Synthesis of Curable Resin (C))

Into a reaction flask, 116 parts by weight of 2-hydroxyethyl acrylate and 340 parts by weight of 7-butyl-2-oxepanone were put, and to this, 0.3 parts by weight of p-methoxy phenol as a polymerization inhibitor was added, and the content of the flask was heated to 90° C. with a mantle heater and stirred for 5 hours. To the stirred product, 148 parts by weight of phthalic anhydride was added, and the resulting mixture was further stirred for 5 hours.

Subsequently, 170 parts by weight of bisphenol A diglycidyl ether was added and the resulting mixture was stirred at 90° C. for 5 hours to obtain a curable resin (C).

### (Synthesis of Curable Resin (D))

Into a reaction flask, 144 parts by weight of 4-hydroxybutyl acrylate, 0.3 parts by weight of p-methoxy phenol as a polymerization inhibitor, and 148 parts by weight of phthalic anhydride were put, and the content of the flask was heated to 90° C. with a mantle heater and stirred for 5 hours.

Subsequently, 170 parts by weight of bisphenol A diglycidyl ether was added and the resulting mixture was stirred at 90° C. for 5 hours to obtain a curable resin (D).

### (Synthesis of Curable Resin (E))

Into a reaction flask, 144 parts by weight of 4-hydroxybutyl acrylate and 217 parts by weight of β-propiolactone were put, and to this, 0.3 parts by weight of p-methoxy phenol as a polymerization inhibitor was added, and the content of the flask was heated to 90° C. with a mantle heater and stirred for 5 hours. To the stirred product, 148 parts by weight of phthalic anhydride was added, and the resulting mixture was further stirred for 5 hours.

Subsequently, 170 parts by weight of bisphenol A diglycidyl ether was added and the resulting mixture was stirred at 90° C. for 5 hours to obtain a curable resin (E).

### (Synthesis of Curable Resin (F))

Into a reaction flask, 144 parts by weight of 4-hydroxybutyl acrylate and 340 parts by weight of 7-butyl-2-oxepanone were put, and to this, 0.3 parts by weight of p-methoxy phenol as a polymerization inhibitor was added, and the content of the flask was heated to 90° C. with a mantle heater and stirred for 5 hours. To the stirred product, 148 parts by weight of phthalic anhydride was added, and the resulting mixture was further stirred for 5 hours.

Subsequently, 170 parts by weight of bisphenol A diglycidyl ether was added and the resulting mixture was stirred at 90° C. for 5 hours to obtain a curable resin (F).

### (Synthesis of Curable Resin (G))

Into a reaction flask, 144 parts by weight of 4-hydroxybutyl acrylate and 680 parts by weight of 7-butyl-2-oxepanone were put, and to this, 0.3-parts by weight of p-methoxy phenol as a polymerization inhibitor was added, and the content of the flask was heated to 90° C. with a mantle heater and stirred for 5 hours. To the stirred product, 148 parts by weight of phthalic anhydride was added, and the resulting mixture was further stirred for 5 hours.

Subsequently, 170 parts by weight of bisphenol A diglycidyl ether was added and the resulting mixture was stirred at 90° C. for 5 hours to obtain a curable resin (G).

### (Synthesis of Curable Resin (H))

Into a reaction flask, 144 parts by weight of 4-hydroxybutyl acrylate and 340 parts by weight of 7-butyl-2-oxepanone were put, and to this, 0.3 parts by weight of p-methoxy phenol as a polymerization inhibitor was added, and the content of the flask was heated to 90° C. with a mantle heater and stirred for 5 hours. To the stirred product, 148 parts by weight of phthalic anhydride was added, and the resulting mixture was further stirred for 5 hours.

Subsequently, 150 parts by weight of glycidyl phenyl ether was added and the resulting mixture was stirred at 90° C. for 5 hours to obtain a curable resin (H).

### (Synthesis of Curable Resin (I))

Into a reaction flask, 72 parts by weight of acrylic acid and 312 parts by weight of bisphenol F diglycidyl ether were put, and to this, 0.3 parts by weight of p-methoxy phenol as a polymerization inhibitor and 0.3 parts by weight of triethylamine as a reaction catalyst were added, and the content of the flask was heated to 90° C. with a mantle heater and stirred for 5 hours to obtain a curable resin (I) having a remaining epoxy group.

### EXAMPLE 1

3 parts by weight of a photopolymerization initiator (produced by Light Chemical Industries Co., Ltd., KR-02), 20 parts by weight of the synthesized curable resin (A), 10 parts by weight of bisphenol A type epoxy acrylate resin (produced by DAICEL-CYTEC Co., Ltd., EB 3700), 30 parts by weight of the synthesized curable resin (I), 1 part by weight of a silane coupling agent (produced by Shin-Etsu Chemical Co., Ltd., KBM403), 15 parts by weight of silica (produced by Admatechs Co., Ltd., SO-C1), and 3.5 parts by weight of a thermally curing agent (produced by Ajinomoto Fine-Techno Co., Inc., VDH) were mixed, and the resulting mixture was stirred with a planetary mixer and then dispersed uniformly with a ceramic three roll to obtain a sealant A.

### EXAMPLE 2

3 parts by weight of a photopolymerization initiator (produced by Light Chemical Industries Co., Ltd., KR-02), 20 parts by weight of the synthesized curable resin (B), 10 parts by weight of bisphenol A type epoxy acrylate resin (produced by DAICEL-CYTEC Co., Ltd., EB 3700), 30 parts by weight of the synthesized curable resin (I), 1 part by weight of a silane coupling agent (produced by Shin-Etsu Chemical Co., Ltd., KBM403), 15 parts by weight of silica (produced by Admatechs Co., Ltd., SO-C1), and 3.5 parts by weight of a thermally curing agent (produced by Ajinomoto Fine-Techno Co., Inc., VDH) were mixed, and the resulting mixture was stirred with a planetary mixer and then dispersed uniformly with a ceramic three roll to obtain a sealant B.

### EXAMPLE 3

3 parts by weight of a photopolymerization initiator (produced by Light Chemical Industries Co., Ltd., KR-02), 20 parts by weight of the synthesized curable resin (C), 10 parts by weight of bisphenol A type epoxy acrylate resin (produced by DAICEL-CYTEC Co., Ltd., EB 3700), 30 parts by weight of the synthesized curable resin (I), 1 part by weight of a silane coupling agent (produced by Shin-Etsu Chemical Co., Ltd., KBM403), 15 parts by weight of silica (produced by Admatechs Co., Ltd., SO-C1), and 3.5 parts by weight of a thermally curing agent (produced by Ajinomoto Fine-Techno Co., Inc., VDH) were mixed, and the resulting mixture was stirred with a planetary mixer and then dispersed uniformly with a ceramic three roll to obtain a sealant C.

### EXAMPLE 4

3 parts by weight of a photopolymerization initiator (produced by Light Chemical Industries Co., Ltd., KR-02), 20 parts by weight of the synthesized curable resin (D), 10 parts by weight of bisphenol A type epoxy acrylate resin (produced by DAICEL-CYTEC Co., Ltd., EB 3700), 30 parts by weight of the synthesized curable resin (I), 1 part by weight of a silane coupling agent (produced by Shin-Etsu Chemical Co., Ltd., KBM403), 15 parts by weight of silica (produced by Admatechs Co., Ltd., SO-C1), and 3.5 parts by weight of a thermally curing agent (produced by Ajinomoto Fine-Techno Co., Inc., VDH) were mixed, and the resulting mixture was stirred with a planetary mixer and then dispersed uniformly with a ceramic three roll to obtain a sealant D.

### EXAMPLE 5

3 parts by weight of a photopolymerization initiator (produced by Light Chemical Industries Co., Ltd., KR-02), 20 parts by weight of the synthesized curable resin (E), 10 parts by weight of bisphenol A type epoxy acrylate resin (produced by DAICEL-CYTEC Co., Ltd., EB 3700), 30 parts by weight of the synthesized curable resin (I), 1 part by weight of a silane coupling agent (produced by Shin-Etsu Chemical Co., Ltd., KBM403), 15 parts by weight of silica (produced by Admatechs Co., Ltd., SO-C1), and 3.5 parts by weight of a thermally curing agent (produced by Ajinomoto Fine-Techno Co., Inc., VDH) were mixed, and the resulting mixture was stirred with a planetary mixer and then dispersed uniformly with a ceramic three roll to obtain a sealant E.

### EXAMPLE 6

3 parts by weight of a photopolymerization initiator (produced by Light Chemical Industries Co., Ltd., KR-02), 20 parts by weight of the synthesized curable resin (F), 10 parts by weight of bisphenol A type epoxy acrylate resin (produced by DAICEL-CYTEC Co., Ltd., EB 3700), 30 parts by weight of the synthesized curable resin (I), 1 part by weight of a silane coupling agent (produced by Shin-Etsu Chemical Co., Ltd., KBM403), 15 parts by weight of silica (produced by Admatechs Co., Ltd., SO-C1), and 3.5 parts by weight of a thermally curing agent (produced by Ajinomoto Fine-Techno Co., Inc., VDH) were mixed, and the resulting mixture was stirred with a planetary mixer and then dispersed uniformly with a ceramic three roll to obtain a sealant F.

### EXAMPLE 7

3 parts by weight of a photopolymerization initiator (produced by Light Chemical Industries Co., Ltd., KR-02), 20 parts by weight of the synthesized curable resin (G), 10 parts by weight of bisphenol A type epoxy acrylate resin (produced by DAICEL-CYTEC Co., Ltd., EB 3700), 30 parts by weight of the synthesized curable resin (I), 1 part by weight of a silane coupling agent (produced by Shin-Etsu Chemical Co., Ltd., KBM403), 15 parts by weight of silica (produced by Admatechs Co., Ltd., SO-C1), and 3.5 parts by weight of a thermally curing agent (produced by Ajinomoto Fine-Techno Co., Inc., VDH) were mixed, and the resulting mixture was stirred with a planetary mixer and then dispersed uniformly with a ceramic three roll to obtain a sealant G.

### EXAMPLE 8

3 parts by weight of a photopolymerization initiator (produced by Light Chemical Industries Co., Ltd., KR-02), 20 parts by weight of the synthesized curable resin (H), 10 parts by weight of bisphenol A type epoxy acrylate resin (produced by DAICEL-CYTEC Co., Ltd., EB 3700), 30 parts by weight of the synthesized curable resin (I), 1 part by weight of a silane coupling agent (produced by Shin-Etsu Chemical Co., Ltd., KBM403), 15 parts by weight of silica (produced by Admatechs Co., Ltd., SO-C1), and 3.5 parts by weight of a thermally curing agent (produced by Ajinomoto Fine-Techno Co., Inc., VDH) were mixed, and the resulting mixture was stirred with a planetary mixer and then dispersed uniformly with a ceramic three roll to obtain a sealant H.

### EXAMPLE 9

3 parts by weight of a photopolymerization initiator (produced by Light Chemical Industries Co., Ltd., KR-02), 20 parts by weight of epoxy acrylate having a long chain methylene group (produced by DAICEL-CYTEC Co., Ltd., KRM7856), 10 parts by weight of bisphenol A type epoxy acrylate resin (produced by Daicel-UCB Co., Ltd., EB 3700), 30 parts by weight of the synthesized curable resin (I), 1 part by weight of a silane coupling agent (produced by Shin-Etsu Chemical Co., Ltd., KBM403), 15 parts by weight of silica (produced by Admatechs Co., Ltd., SO-C1), and 3.5 parts by weight of a thermally curing agent (produced by Otsuka Chemical Co., Ltd., adipic acid dihydrazide) were mixed, and the resulting mixture was stirred with a planetary mixer and then dispersed uniformly with a ceramic three roll to obtain a sealant I.

### EXAMPLE 10

3 parts by weight of a photopolymerization initiator (produced by Light Chemical Industries Co., Ltd., KR-02), 30 parts by weight of epoxy acrylate having a long chain methylene group (produced by DAICEL-CYTEC Co., Ltd., KRM7856), 30 parts by weight of the synthesized curable resin (I), 1 part by weight of a silane coupling agent (produced by Shin-Etsu Chemical Co., Ltd., KBM403), 15 parts by weight of silica (produced by Admatechs Co., Ltd., SO-C1), and 3.5 parts by weight of a thermally curing agent (produced by Otsuka Chemical Co., Ltd., adipic acid dihydrazide) were mixed, and the resulting mixture was stirred with a planetary mixer and then dispersed uniformly with a ceramic three roll to obtain a sealant J.

### EXAMPLE 11

3 parts by weight of a photopolymerization initiator (produced by Light Chemical Industries Co., Ltd., KR-02), 40 parts by weight of epoxy acrylate having a long chain methylene group (produced by DAICEL-CYTEC Co., Ltd., KRM7856), 20 parts by weight of the synthesized curable resin (I), 1 part by weight of a silane coupling agent (produced by Shin-Etsu Chemical Co., Ltd., KBM403), 15 parts by weight of silica (produced by Admatechs Co., Ltd., SO-C1), and 2.3 parts by weight of a thermally curing agent (produced by Otsuka Chemical Co., Ltd., adipic acid dihydrazide) were mixed, and the resulting mixture was stirred with a planetary mixer and then dispersed uniformly with a ceramic three roll to obtain a sealant K.

### COMPARATIVE EXAMPLE 1

3 parts by weight of a photopolymerization initiator (produced by Light Chemical Industries Co., Ltd., KR-02), 30 parts by weight of bisphenol A type epoxy acrylate resin (produced by DAICEL-CYTEC Co., Ltd., EB 3700), 30 parts by weight of the synthesized curable resin (I), 1 part by weight of a silane coupling agent (produced by Shin-Etsu Chemical Co., Ltd., KBM403), 15 parts by weight of silica (produced by Admatechs Co., Ltd., SO-C1), and 3.5 parts by weight of a thermally curing agent (produced by Otsuka Chemical Co., Ltd., adipic acid dihydrazide) were mixed, and the resulting mixture was stirred with a planetary mixer and then dispersed uniformly with a ceramic three roll to obtain a sealant L.

### COMPARATIVE EXAMPLE 2

3 parts by weight of a photopolymerization initiator (produced by Light Chemical Industries Co., Ltd., KR-02), 60 parts by weight of the synthesized epoxy acrylate (A), 1 part by weight of a silane coupling agent (produced by Shin-Etsu Chemical Co., Ltd., KBM403), 15 parts by weight of silica (produced by Admatechs Co., Ltd., SO-C1), and 3.5 parts by weight of a thermally curing agent (produced by Otsuka Chemical Co., Ltd., adipic acid dihydrazide) were mixed, and the resulting mixture was stirred with a planetary mixer and then dispersed uniformly with a ceramic three roll to obtain a sealant M.

### (Evaluation)

The following evaluations were conducted using the sealants obtained in Examples 1 to 11 and Comparative Examples 1 to 2.

(Fabrication of Liquid Crystal Panel)

1 part by weight of spacer particles (produced by SEKISUI CHEMICAL CO., LTD.; ⊚ SI-H050, 5 μm) were dispersed in 100 parts by weight of each sealant obtained, and the resulting dispersion was deaerated by a centrifugal deaerator (Awatron AW-1). The deaerated dispersion was applied to one of two substrates with an alignment layer and a transparent electrode as a sealant for a One prop Fill process in such a way that a line width of the sealant is 1 mm with a dispenser.

Subsequently, a small droplet of liquid crystal (produced by Chisso Corporation, JC-5004LA) was dispensed and applied to the whole area within a frame of the sealant of the substrate with a transparent electrode, and on this, the other color filter substrate with a transparent electrode was overlaid immediately, and light was irradiated to the sealant portion at 100 mW/cm² for 30 seconds with a metal halide lamp to cure the sealant temporarily. The sealant was heated at 120° C. for 1 hour to cure the sealant fully to prepare a liquid crystal display panel.

### (Evaluation of Dispensing Property of Sealant (Evaluation of Workability))

Using the sealants obtained in Examples 1 to 11 and Comparative Examples 1 to 2, 20 liquid crystal panels for each sealant were fabricated in the conditions of a syringe discharge pressure of 300 kPa, a nozzle gap of 42 μm, an application speed of 80 mm/sec, and a nozzle bore size of 0.4 mm, and number of defective panels caused by breaking of wire was counted. The results were shown in Table 1. The sealants were evaluated in the following four classes in accordance with the number of defective panels.

⊚:number of defective panels 0
◯:number of defective panels 1 to 2
Δ:number of defective panels 3 to 5
x:number of defective panels 5 or more

### (Evaluation of Liquid Crystal Panel (Evaluation of Color Irregularity))

The alignment defects of liquid crystals near the sealant immediately after preparing the display panel were visually observed on the obtained liquid crystal display panels. The alignment defects were judged based on the color irregularity of the display section and the sealants were evaluated in the following four classes in accordance with the degree of color irregularity. The results were shown in Table 1. Incidentally, the liquid crystal panels evaluated as ⊚, and ◯ are practically of no problem.

⊚:There is no color irregularity.
◯:There is little color irregularity.
Δ:There is a little color irregularity.
x:There is a considerable color irregularity.

### (Evaluation of Adhesion of Multi-Layer Film Substrate)

As shown in FIG. 1, the sealants 10 obtained in Examples 1 to 11 and Comparative Examples 1 to 2 were dispensed to the four sides which are distance of 30 mm from the edges of a glass substrate 13 (90 mm×90 mm), and a glass substrate 11 (70 mm×70 mm), on which polyimide, ITO, chromium, a resin black matrix, and carbon are formed as a film 12, was overlaid on and bonded to the substrate 13 under vacuum. Ultraviolet light (100 mW/cm², 3000 mJ) was irradiated, and subsequently the bonded glass substrate was heated at 120° C. for 1 hour to cure the sealant and obtain an adhesion test piece.

An edge portion of the substrate of the prepared adhesion test piece panel was pushed at a speed of 5 mm/min by a metal cylinder of 5 mm in radius and the strength at the time when the panel was peeled off was measured and a peeling state was observed. The results of the evaluation were shown in Table 1.

In addition, when the glass substrate was cracked before the panel was peeled off because of high adhesion of the sealant, it was regarded as cracking of a substrate. And, with respect to a peeling state, as shown in FIG. 1, peeling of a glass substrate from a film was regarded as “peeling A” and peeling of a glass substrate from a glass substrate was regarded as “peeling B”.

TABLE 1

| | | | Color | | | | | | |
|---|---|---|---|---|---|---|---|---|---|
| | | Workability | irregularity | Adhesion test | | | | | |
| | | test | test | Glass | Polyimide | ITO | Chromium | Resin BM | Carbone |
| Example 1 | Sealant A | ⊚ | ◯ | Cracking of | 13 kgf | Cracking of | 10 kgf | 10 kgf | 10 kgf |
| | Peeled surface | | | substrate | A | substrate | A | A | A |
| Example 2 | Sealant B | ⊚ | ◯ | Cracking of | 14 kgf | Cracking of | 12 kgf | 13 kgf | 13 kgf |
| | Peeled surface | | | substrate | A | substrate | A | A | A |
| Example 3 | Sealant C | ⊚ | ⊚ | Cracking of | Cracking of | Cracking of | Cracking of | Cracking of | Cracking of |
| | Peeled surface | | | substrate | substrate | substrate | substrate | substrate | substrate |
| Example 4 | Sealant D | ⊚ | ◯ | Cracking of | 15 kgf | Cracking of | 13 kgf | 12 kgf | 12 kgf |
| | Peeled surface | | | substrate | A | substrate | A | A | A |
| Example 5 | Sealant E | ⊚ | ◯ | Cracking of | Cracking of | Cracking of | Cracking of | Cracking of | Cracking of |
| | Peeled surface | | | substrate | substrate | substrate | substrate | substrate | substrate |
| Example 6 | Sealant F | ⊚ | ⊚ | Cracking of | Cracking of | Cracking of | Cracking of | Cracking of | Cracking of |
| | Peeled surface | | | substrate | substrate | substrate | substrate | substrate | substrate |
| Example 7 | Sealant G | ⊚ | ◯ | Cracking of | Cracking of | Cracking of | Cracking of | Cracking of | Cracking of |
| | Peeled surface | | | substrate | substrate | substrate | substrate | substrate | substrate |
| Example 8 | Sealant H | ⊚ | ◯ | Cracking of | 12 kgf | Cracking of | 10 kgf | 10 kgf | 10 kgf |
| | Peeled surface | | | substrate | A | substrate | A | A | A |
| Example 9 | Sealant I | ⊚ | ⊚ | Cracking of | Cracking of | Cracking of | Cracking of | Cracking of | Cracking of |
| | Peeled surface | | | substrate | substrate | substrate | substrate | substrate | substrate |
| Example 10 | Sealant J | ⊚ | ⊚ | Cracking of | Cracking of | Cracking of | Cracking of | Cracking of | Cracking of |
| | Peeled surface | | | substrate | substrate | substrate | substrate | substrate | substrate |
| Example 11 | Sealant K | ◯ | ⊚ | Cracking of | Cracking of | Cracking of | Cracking of | Cracking of | Cracking of |
| | Peeled surface | | | substrate | substrate | substrate | substrate | substrate | substrate |
| Comparative | Sealant L | ⊚ | ⊚ | 18 kgf | 9 kgf | 13 kgf | 7 kgf | 8 kgf | 6 kgf |
| Example 1 | Peeled surface | | | A and B | A | A and B | A | A | A |
| Comparative | Sealant M | X | ◯ | Cracking of | Cracking of | Cracking of | Cracking of | Cracking of | Cracking of |
| Example 2 | Peeled surface | | | substrate | substrate | substrate | substrate | substrate | substrate |

### Synthesis of Epoxy Acrylate

120 g of EX-201 (resorcinol type epoxy resin) was dissolved in 500 mL of toluene, and to this solution, 0.1 g of triphenylphosphine was added to prepare a uniform solution. 70 g of acrylic acid was added dropwise to this solution over 2 hours under reflux while stirring, and then the reflux and stirring were performed for 8 hours.

Next, by removing toluene, epoxy (meth)acrylate (a modified product of EX-201: viscosity 60 Pa) in which all epoxy groups were transformed to acryloyl groups was synthesized

### EXAMPLE 12

60 parts by weight of the modified product of EX-201, 40 parts by weight of EPIKOTE 828 (produced by Japan Epoxy Resins Co., Ltd.), 2 parts by weight of IRGACURE 651 (produced by Ciba Specialty Chemicals K.K.), 10 parts by weight of AMICURE VDH-J (produced by Ajinomoto Fine-Techno Co., Inc.), 3 parts by weight of KBM403 (produced by Shin-Etsu Chemical Co., Ltd.), and 30 parts by weight of SO-C1 (produced by Admatechs Co., Ltd.) were mixed with a planetary mixer (Awatori Rentaro: manufactured by THINKY Corporation), and then further mixed with a three roll to prepare a sealant.

The prepared sealant was applied onto a substrates with a black matrix (BM) and a transparent electrode so as to pattern a rectangular frame by a dispenser. Subsequently, a small droplet of liquid crystal (produced by Chisso Corporation, JC-5004LA) was dispensed and applied to the whole area within the frame of the transparent substrate, and on this, the other substrate (without a BM) with a transparent electrode was overlaid immediately, and ultraviolet light was irradiated from the substrate with a BM side to the sealed portion at 50 mW/cm² for 20 seconds with a high-pressure mercury lamp. In this time, a line width of the squashed sealant was about 1.2 mm, and the sealant of 0.3 mm of this width of 1.2 mm was patterned so as to overlap the BM. Thereafter, annealing of liquid crystal was performed at 120° C. for 1 hour and simultaneously the sealant was thermally cured to prepare a liquid crystal display panel.

In addition, the proportion of the (meth)acryloyl group was 60 mol % of the reactive functional group existing in the thermally curable resin in the sealant prepared in Example 12.

### EXAMPLE 13

80 parts by weight of the modified product of EX-201, parts by weight of EPIKOTE 828 (produced by Japan Epoxy Resins Co., Ltd.), 2 parts by weight of IRGACURE 651 (produced by Ciba Specialty Chemicals K.K.), 10 parts by weight of AMICURE VDH-J (produced by Ajinomoto Fine-Techno Co., Inc.), 3 parts by weight of KBM403 (produced by Shin-Etsu Chemical Co., Ltd.), and 30 parts by weight of SO-C1 (produced by Admatechs Co., Ltd.) were mixed with a planetary mixer (Awatori Rentaro: manufactured by THINKY Corporation), and then further mixed with a three roll to prepare a sealant.

A liquid crystal display panel was fabricated by following the same procedure as in Example 12 except for using the prepared sealant of Example 13

In addition, the proportion of the (meth)acryloyl group was 80 mol % of the reactive functional group existing in the curable resin in the sealant prepared in Example 13.

### EXAMPLE 14

100 parts by weight of the modified product of EX-201, 2 parts by weight of IRGACURE 651 (produced by Ciba Specialty Chemicals K.K.), 10 parts by weight of AMICURE VDH-J (produced by Ajinomoto Fine-Techno Co., Inc.), 3 parts by weight of KBM403 (produced by Shin-Etsu Chemical Co., Ltd.), and 30 parts by weight of SO-C1 (produced by Admatechs Co., Ltd.) were mixed with a planetary mixer (Awatori Rentaro: manufactured by THINKY Corporation), and then further mixed with a three roll to prepare a sealant.

A liquid crystal display panel was then fabricated by following the same procedure as in Example 12 except for using the prepared sealant of Example 14.

In addition, the proportion of the (meth)acryloyl group was 100 mol % of the reactive functional group existing in the curable resin in the sealant prepared in Example 14.

### EXAMPLE 15

80 parts by weight of the modified product of EX-201, parts by weight of EPIKOTE 828 (produced by Japan Epoxy Resins Co., Ltd.), 2 parts by weight of IRGACURE 651 (produced by Ciba Specialty Chemicals K.K.), 5 parts by weight of 2MZA-PW (produced by SHIKOKU CHEMICALS CORPORATION), 3 parts by weight of KBM403 (produced by Shin-Etsu Chemical Co., Ltd.), and 30 parts by weight of SO-C1 (produced by Admatechs Co., Ltd.) were mixed with a planetary mixer (Awatori Rentaro: manufactured by THINKY Corporation), and then further mixed with a three roll to prepare a sealant.

A liquid crystal display panel was then fabricated by following the same procedure as in Example 12 except for using the prepared sealant of Example 15.

In addition, the proportion of the (meth)acryloyl group was 80 mol % of the reactive functional group existing in the curable resin in the sealant prepared in Example 15.

### EXAMPLE 16

80 parts by weight of the modified product of EX-201, parts by weight of EPIKOTE 828 (produced by Japan Epoxy Resins Co., Ltd.), 2 parts by weight of IRGACURE 819 (produced by Ciba Specialty Chemicals K.K.), 10 parts by weight of AMICURE VDH-J (produced by Ajinomoto Fine-Techno Co., Inc.), 3 parts by weight of KBM403 (produced by Shin-Etsu Chemical Co., Ltd.), and 30 parts by weight of SO-C1 (produced by Admatechs Co., Ltd.) were mixed with a planetary mixer (Awatori Rentaro: manufactured by THINKY Corporation), and then further mixed with a three roll to prepare a sealant.

A liquid crystal display panel was fabricated by following the same procedure as in Example 12 except for using the prepared sealant of Example 16.

In addition, the proportion of the (meth)acryloyl group was 80 mol % of the reactive functional group existing in the curable resin in the sealant prepared in Example 16.

### EXAMPLE 17

80 parts by weight of the modified product of EX-201, parts by weight of EPIKOTE 828 (produced by Japan Epoxy Resins Co., Ltd.), 2 parts by weight of IRGACURE 651 (produced by Ciba Specialty Chemicals K.K.), 10 parts by weight of milled ADH (produced by Otsuka Chemical Co., Ltd.), 3 parts by weight of KBM403 (produced by Shin-Etsu Chemical Co., Ltd.), and 30 parts by weight of SO-C1 (produced by Admatechs Co., Ltd.) were mixed with a planetary mixer (Awatori Rentaro: manufactured by THINKY Corporation), and then further mixed with a three roll to prepare a sealant.

A liquid crystal display panel was fabricated by following the same procedure as in Example 12 except for using the prepared sealant of Example 17.

In addition, the proportion of the (meth)acryloyl group was 80 mol % of the reactive functional group existing in the curable resin in the sealant prepared in Example 17.

### COMPARATIVE EXAMPLE 3

80 parts by weight of the modified product of EX-201, parts by weight of EPIKOTE 828 (produced by Japan Epoxy Resins Co., Ltd.), 2 parts by weight of IRGACURE 2959 (produced by Ciba Specialty Chemicals K.K.), 10 parts by weight of AMICURE VDH-J (produced by Ajinomoto Fine-Techno Co., Inc.), 3 parts by weight of KBM403 (produced by Shin-Etsu Chemical Co., Ltd.), and 30 parts by weight of SO-C1 (produced by Admatechs Co., Ltd.) were mixed with a planetary mixer (Awatori Rentaro: manufactured by THINKY Corporation), and then further mixed with a three roll to prepare a sealant.

A liquid crystal display panel was fabricated by following the same procedure as in Example 12 except for using the prepared sealant of Comparative Example 3.

In addition, the proportion of the (meth)acryloyl group was 80 mol % of the reactive functional group existing in the curable resin in the sealant prepared in Comparative Example 3.

### COMPARATIVE EXAMPLE 4

40 parts by weight of the modified product of EX-201, 60 parts by weight of EPIKOTE 828 (produced by Japan Epoxy Resins Co., Ltd.), 2 parts by weight of IRGACURE 651 (produced by Ciba Specialty Chemicals K.K.), 10 parts by weight of AMICURE VDH-J (produced by Ajinomoto Fine-Techno Co., Inc.), 3 parts by weight of KBM403 (produced by Shin-Etsu Chemical Co., Ltd.), and 30 parts by weight of SO-C1 (produced by Admatechs Co., Ltd.) were mixed with a planetary mixer (Awatori Rentaro: manufactured by THINKY Corporation), and then further mixed with a three roll to prepare a sealant.

A liquid crystal display panel was fabricated by following the same procedure as in Example 12 except for using the prepared sealant of Comparative Example 4.

In addition, the proportion of the (meth)acryloyl group was 40 mol % of the reactive functional group existing in the curable resin in the sealant prepared in Comparative Example 4.

### (Evaluation)

The following evaluations were performed on the sealants and the liquid crystal display devices prepared in Examples 12 to 17 and Comparative Examples 3 to 4.

### (1) Stability Under Fluorescent Lamp

The obtained sealants were left standing for 12 hours under a fluorescent lamp to investigate their changes in viscosity. The results were shown in Table 2. In Table 2, a symbol ◯ represents a sealant which increased in viscosity by 2-fold or less and x represent a sealant which increased in viscosity by 2-fold or more.

### (2) Adhesion Strength

3 parts by weight of polymer beads (produced by SEKISUI CHEMICAL CO., LTD.; Micropearl SP) having an average particle diameter of 5 μm were dispersed in 100 parts by weight of each sealant obtained with a planetary mixer to form a uniform solution. A trace amount of this solution was placed on a central portion of Corning glass 1737 (20 mm×50 mm×1.1 mmt), and the same type of glass was overlaid on this to squash the sealant, and ultraviolet light was irradiated to the sealant at 50 mW/cm² for 60 seconds. Thereafter, the sealant was heated at 120° C. for 1 hour to obtain an adhesion test piece. Adhesion strength of this test piece was measured using a tension gauge (comparison unit; N/cm²).

The results were shown in Table 2.

(3) Measurement of Conversion Ratio of Acryloyl Group Under Pattern After UV Irradiation (refer to FIG. 3)

First, a substrate 1 formed by depositing chromium by vapor deposition on a half area of Corning glass 0.7 mmt and a substrate 2 formed by depositing chromium by vapor deposition on the whole area were prepared separately (FIG. 3(a)). A sealant including polymer beads was applied to a central portion A of the substrate 1, and to this, the substrate 2 was bonded to adequately squash the sealant (FIG. 3(b)).

Next, ultraviolet light was irradiated to the bonded substrate at 50 mW/cm² for 60 seconds from the substrate surface, and then the substrate 1 was peeled off from the substrate 2 with a cutter, and spectra of the sealants on an area (location 1), to which UV was directly irradiated, an area (location 2) distance of 100 μm from the end of the area, to which UV was directly irradiated, an area (location 3) distance of 200 μm from the end of the area, to which UV was directly irradiated, and an area (location 4) distance of 300 μm from the end of the area, to which UV was directly irradiated were analyzed by an infrared microspectroscopy, and a conversion ratio of an acryl functional group in the sealant was determined from each spectrum.(FIG. 3(c))

Further, quantitative analysis of an acryl functional group was performed using a peak area at 810 m⁻¹. The results were shown in Table 2.

### (4) Evaluation of Panel Display Color Irregularity

Color irregularities produced in liquid crystals surrounding a sealed portion-were visually observed according to the following criteria on the liquid crystal display panels obtained in Examples 12 to 17 and Comparative Examples 3 to 4.

⊚:There is no color irregularity.
◯:There is little color irregularity.
Δ:There is a little color irregularity.
x:There is a considerable color irregularity

The results were shown in Table 2.

TABLE 2

| | | | | | | | | Compar- | Compar- |
|---|---|---|---|---|---|---|---|---|---|
| | | | | | | | | ative | ative |
| | | Exam- | Exam- | Exam- | Exam- | Exam- | Exam- | Exam- | Exam- |
| | | ple 12 | ple 13 | ple 14 | ple 15 | ple 16 | ple 17 | ple 3 | ple 4 |
| Formulation | Modified product of EX-201 | 60 | 80 | 100 | 80 | 80 | 80 | 80 | 40 |
| (parts by | EPIKOTE 828 | 40 | 20 | | 20 | 20 | 20 | 20 | 60 |
| weight) | IRGACURE 651 | 2 | 2 | 2 | 2 | | 2 | | 2 |
| | IRGACURE 819 | | | | | 2 | | | |
| | IRGACURE 2959 | | | | | | | 2 | |
| | AMICURE VDH-J | 10 | 10 | 10 | | 10 | | 10 | 10 |
| | ADH(Milled) | | | | | | 10 | | |
| | 2MZA-PW | | | | 5 | | | | |
| | KBM403 | 3 | 3 | 3 | 3 | 3 | 3 | 3 | 3 |
| | SO-C1 | 30 | 30 | 30 | 30 | 30 | 30 | 30 | 30 |

| | | | | | | | | |
|---|---|---|---|---|---|---|---|---|
| Stability under fluorescent lamp | ⊚ | ⊚ | ⊚ | ⊚ | X | ⊚ | ⊚ | ⊚ |
| Adhesion strength (N/cm²) | 350 | 310 | 200 | 320 | 280 | 310 | 320 | 389 |
| Conversion ratio of acryloyl group under | 92 | 95 | 95 | 91 | 95 | 95 | 95 | 95 |
| pattern after UV irradiation:location 1(%) | | | | | | | | |
| Conversion ratio of acryloyl group under | 78 | 81 | 83 | 77 | 88 | 79 | 53 | 81 |
| pattern after UV irradiation:location 2(%) | | | | | | | | |
| Conversion ratio of acryloyl group under | 61 | 65 | 62 | 59 | 77 | 63 | 25 | 65 |
| pattern after UV irradiation:location 3(%) | | | | | | | | |
| Conversion ratio of acryloyl group under | 59 | 57 | 58 | 51 | 71 | 55 | 0 | 59 |
| pattern after UV irradiation:location 4(%) | | | | | | | | |
| Panel display color irregularity | ◯ | ⊚ | ⊚ | ◯ | ⊚ | ⊚ | X | X |

### INDUSTRIAL APPLICABILITY

In accordance with the present invention, it is possible to provide a sealant for a One prop Fill process which hardly causes a peeling phenomenon between the sealant and a substrate in fabrication of liquid crystal display device since the sealant has excellent adhesion to the substrate, and which is most suitable for fabricating a liquid crystal display device having low color irregularity in liquid crystal display since the sealant does not cause liquid crystal contamination, and it is possible to provide a sealant for a One prop Fill process, in which in fabrication of liquid crystal display device by a One prop Fill process, even a portion where light may be not directly irradiated can be adequately cured, a liquid crystal is not deteriorated by ultraviolet light to be irradiated in curing the sealant, and thereby, high display quality and high reliability of the liquid crystal display device can be realized, a vertically conducting material, and a liquid crystal display device formed by using these materials.

### BRIEF DESCRIPTION OF THE DRAWINGS

FIG. 1 is a view illustrating evaluation methods of the liquid crystal display devices fabricated in Examples 1 to 11 and Comparative Examples 1 to 2,

FIG. 2 is a sectional view schematically showing an example of a liquid crystal display device, and

FIG. 3 is a view illustrating a method of measuring the conversion ratio of an acryloyl group under a pattern after UV irradiation of sealants obtained in Examples 12 to 17 and Comparative Examples 3 to 4.

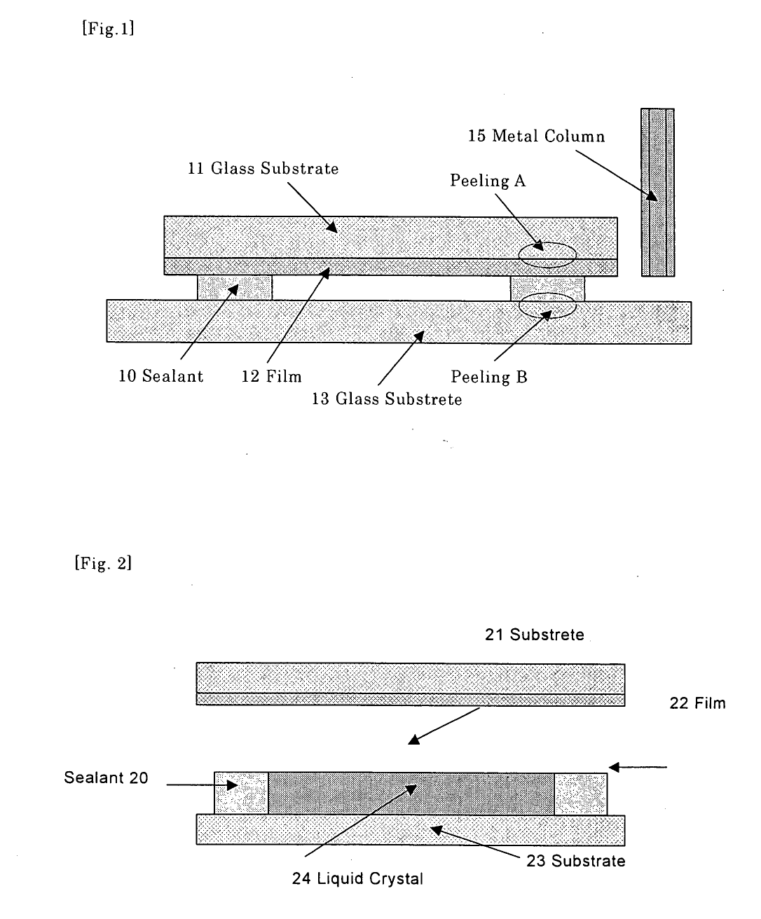

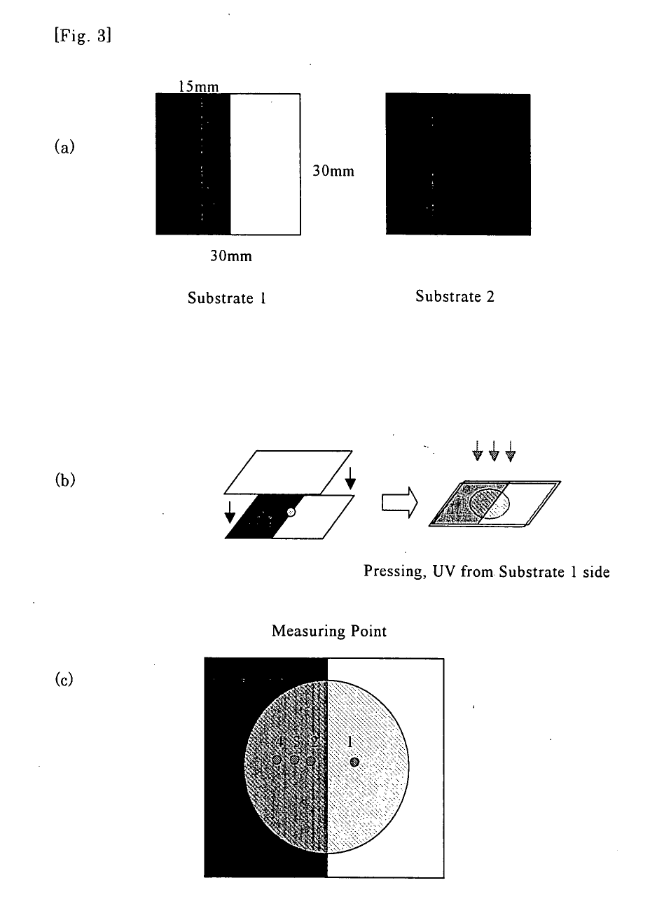

### EXPLANATION OF SYMBOLS

1, 2 substrate
10, 20 sealant
11, 13 glass substrate
12, 22 film
21, 23 substrate
24 liquid crystal

1-15. (canceled)

16. A sealant for a One prop Fill process,
which contains a (meth)acrylate compound having a structure represented by the following general formula (1), 10 to 70% by weight of a curable resin component contained in the sealant being the (meth)acrylate compound: in the general formula (1), R¹ represents a hydrogen atom or a methyl group, X represents one species selected from the group expressed by the following chemical formula (2), Y represents one species selected from the group expressed by the following chemical formula (3), A represents a ring opening structure of cyclic lactone, and n has a value of zero or one:

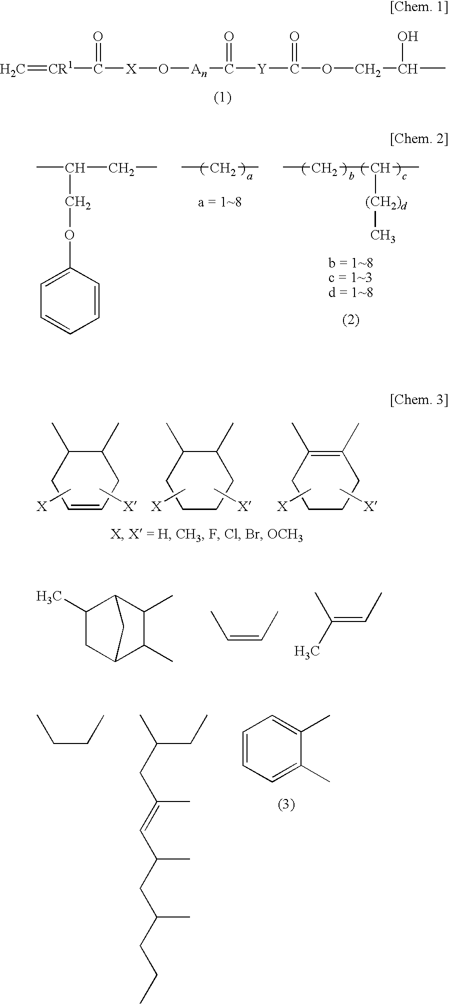

17. The sealant for a One prop Fill process according to claim 16,
wherein the (meth)acrylate compound has a structure derived from lactone.

18. The sealant for a One prop Fill process according to claim 16,
wherein the (meth)acrylate compound has a segment comprising three or more interlinked methylene groups.

19. The sealant for a One prop Fill process according to claim 16,
wherein the (meth)acrylate compound is a polyfunctional (meth)acrylate compound having two or more (meth)acryl groups.

20. A sealant for a One prop Fill process,
which contains a radical polymerization initiator for generating an activated radical by irradiation of light, a curable resin and solid organic acid hydrazide, the radical polymerization initiator having a molar absorption coefficient of 100 to 100000 M⁻¹·cm⁻¹ at 350 nm, measured in acetonitrile, and 60 mol % or more of a reactive functional group contained in said curable resin being a (meth)acryloyl group.

21. The sealant for a One prop Fill process according to claim 20,
wherein the radical polymerization initiator has a molar absorption coefficient of 200 to 10000 M⁻¹·cm⁻¹ at 350 nm, measured in acetonitrile.

22. The sealant for a One prop Fill process according to claim 20,
wherein the radical polymerization initiator has a molar absorption coefficient of 100 M⁻¹·cm⁻¹ or less at 450 nm, measured in acetonitrile.

23. The sealant for a One prop Fill process according to claim 20,
wherein the radical polymerization initiator has a radical polymerization initiating group to produce an activated radical by irradiation of light and a hydrogen-bonding functional group in a molecule.

24. The sealant for a One prop Fill process according to claim 20,
wherein the radical polymerization initiator has a reactive functional group capable of reacting with and capable of bonding to the curable resin.

25. The sealant for a One prop Fill process according to claim 24,
wherein at least one of a reactive functional group capable of reacting with and capable of bonding to the curable resin is a (meth)acryl group and/or an epoxy group.

26. The sealant for a One prop Fill process according to claim 20,
wherein the radical polymerization initiator has a number average molecular weight of 300 or more.

27. The sealant for a One prop Fill process according to claim 20,
wherein the curable resin has the hydrogen-bonding functional group in a molecule.

28. The sealant for a One prop Fill process according to claim 27,
wherein the hydrogen-bonding functional group is a urethane group and/or a hydroxyl group.

29. A vertically conducting material,
which comprises the sealant for a One prop Fill process according to claim 16, 17, 18, 19, 20, 21, 22, 23, 24, 25, 26, 27 or 28 and a conductive particle.

30. A liquid crystal display device,
which is obtained by using the sealant for a One prop Fill process according to claim 16, 17, 18, 19, 20, 21, 22, 23, 24, 25, 26, 27 or 28 and/or the vertically conducting material according to claim 29.
